(19) United States
(12) Patent Application Publication
(10) Pub. No.: US 2023/0331421 A1
(43) Pub. Date: Oct. 19, 2023

(54) Machine For Applying Labels Or Other Markings To Containers

(71) Applicant: Accraply, LLC, Brooklyn Park, MN (US)

(72) Inventors: Melissa Krutchen, Brooklyn Park, MN (US); Peter John Woolls, Colchester (GB); Tecwyn Wright, Salford (GB); Michal Borkowski, Elk River, MN (US); Mike Dunkey, Burlington (CA); Pedro Albino Ribeiro, Manchester (GB); Dale Seamans, Greenfield, MN (US)

(21) Appl. No.: 18/211,893

(22) Filed: Jun. 20, 2023

Related U.S. Application Data
(62) Division of application No. 17/410,671, filed on Aug. 24, 2021.
(60) Provisional application No. 63/168,917, filed on Mar. 31, 2021.

(51) Int. Cl. B65C 9/40; B65C 3/06; B65C 9/04; B65C 9/06

(52) U.S. Cl. CPC B65C 9/04; B65C 3/065; B65C 9/06; B65C 9/40

(57) ABSTRACT

A machine (328) is selectively operative to apply markings such as labels, sleeves, decorations and indicia to containers (340). The machine includes a suspended container conveyor (SC) (320). SC shuttles (336) are selectively independently movable around an SC track (330). The SC shuttles include a respective container engagement fixture (338) and are selectively movable to engage an upper portion of a container. In the container engaged position each container is selectively vertically, rotatably and linearly movable so as to be positioned in operative connection with applicators (434, 436). The applicators are selectively operative to apply markings to respective containers that are in operative connection therewith in a precise and repeatable manner.

### TECHNICAL FIELD

Exemplary arrangements relate to machines that are operative to apply labels or other markings to containers. Exemplary arrangements are particularly applicable to machines that may operate to label or mark containers having varied configurations and sizes.

### BACKGROUND

Containers that are made of plastic, glass or metal are commonly used to hold liquid or solid materials. Such containers commonly require markings thereon to indicate the contents of the container as well as the brand or other source of the material. Such markings may commonly be in the form of labels which are uniformly applied to the containers. Such labels may be in the form of paper or plastic sheets or sleeves that are applied to the containers using adhesives or other attachment methods. Other markings often found on containers include indicia which indicates information such as the particular facility or operation that produced the material, the date the material was produced and/or a “use by” or expiration date associated with the material. Such indicia may be included on a label that is applied to the container or alternatively applied to the container by stamp, inkjet or other printing methods. Containers may also include other types of markings for decorative or information purposes. Containers may be completely painted with specific direct color printers and/or may be printed with images. A single container may have several different kinds of markings applied thereto through differing types of marking methods.

Machines that apply markings to containers need to be able to accurately and repeatedly apply markings to the containers at generally high rates of speed to match production rates. Many types of automated equipment can be used to apply labels or other markings to containers of particular types. Some types of machines include devices that transport containers on a rotary carousel and apply labels and other markings during the time that the containers are being transported. Some types of such machines require time consuming changes in components and operation set up in order to handle different sizes and types of containers. In some cases machines used for labeling and marking containers are limited in terms of the types, sizes and configurations of containers that can be handled by the machine for purposes of applying markings thereto.

Machines used for applying labels or other markings to containers may benefit from improvements.

### SUMMARY

Exemplary arrangements relate to machines that may be used to apply labels or other markings to containers such as bottles, jars and cans. Some exemplary machines include a lower conveyor (LC) and an upper conveyor (UC). In such an exemplary arrangement the LC includes a continuous LC track that extends in a vertical plane. The UC includes a UC track that extends coplanar with the LC track. The exemplary LC track includes an LC labeling track portion that extends substantially linearly straight and horizontally. The UC track includes a UC labeling track portion that extends parallel to and in vertically aligned relation with at least a portion of the LC labeling track portion. In some exemplary arrangements the LC track and the UC track are operatively mounted to a common frame which includes a jack. The jack is selectively adjustable to change the vertical distance between the LC labeling track portion and the UC labeling track portion to readily accommodate handling containers having different vertical dimensions.

In some arrangements a plurality of LC shuttles are operable to move about the LC track. In some exemplary arrangements each of the LC shuttles is operable to move along the track independently of the other LC shuttles. In other arrangements LC shuttles may move in mechanically joined relation with other LC shuttles through engagement with a continuous drive chain or other movable member. In some exemplary arrangements a plurality of UC shuttles are movable on the UC track. In some exemplary arrangements the UC shuttles are similarly independently movable about the UC track. In other arrangements UC shuttles may move in mechanically joined relation with other UC shuttles. Some exemplary LC shuttles may each include a container engagement platform that is configured to engage and support a bottom end of a single container. Some exemplary UC shuttles each include a container engagement fixture that is configured to engage an upper portion of a single container. At least one of the container engagement platform and the container engagement fixture may be in operative connection with a drive. The drive is selectively operative to rotate the respective platform or fixture so as to rotatably move and position the container in engagement therewith for purposes of applying labels or other markings thereto.

At least one applicator may be positioned adjacent to at least one of the LC and UC labeling track portions. The at least one applicator is operative to apply markings to containers in operative engagement with the applicator. The exemplary applicator may be operative to apply labels such as sheets or sleeves to containers or to print or apply indicia or other markings to containers that are moved in engagement with shuttles into operative connection with the applicator. A plurality of applicators may be spaced along the labeling track portion so that multiple different types of markings may be applied to a single container.

In some exemplary arrangements containers such as bottles are fed into the machine. The controller of the machine may be operative responsive to position sensors to engage a respective container with a respective LC shuttle and a respective UC shuttle in a position adjacent to the inlet ends of the respective LC and UC labeling track portions. The container is engaged in a shuttle engaged position in which the container extends vertically between and in operative engagement with each of the respective LC and UC shuttles. In the shuttle engaged position the container is moved in a first direction toward the at least one applicator.

In some exemplary arrangements the controller operates responsive to feature sensors which are operative to sense at least one feature of the container, to cause a drive to rotate the container through rotation of the container engagement platform and/or the container engagement fixture to a desired angular reference position for the application of a label or other markings by the applicator. The container may then be moved in the shuttle engaged position into operative connection with the applicator which operates to apply the markings to the container. In some exemplary arrangements the controller may operate to rotate the container while in operative engagement with the applicator to enable the desired marking of the container.

After the container has been marked with the markings by the applicator, the container may be moved in the shuttle engaged position in the first direction into operative connection with a subsequent applicator to receive additional markings and/or adjacent to at least one optical sensor that senses features that can be used to determine if the markings have been properly applied to the container. Further movement in the first direction causes the container to be released by the shuttles from the shuttle engaged position so that the container may be further processed.

In other exemplary arrangements machines that apply markings to containers may include a suspension container conveyor (SC) which engages and positions containers via the upper portions thereof and does not include a corresponding LC. Such machines may be operable to engage containers with SC shuttles that are selectively movable about the SC. Such a shuttle may hold a container in operative engagement with the shuttle and suspended by engagement of a fixture with the upper portion such as a neck of the container. The container may be suitably moved and positioned in operative connection with the shuttle so as to have markings applied thereto. Such arrangements may also provide for the pressurization of empty containers during movement and marking activities so that such containers that may be comprised of flexible material maintain a desired shape during marking operations.

Of course it should be understood that the features and functions described herein are exemplary and in other arrangements other features, functions and capabilities may be provided by machines that utilize aspects of the described arrangements.

### BRIEF DESCRIPTION OF DRAWINGS

FIG. 1 is a schematic front view of an exemplary arrangement of a machine for applying labels or other markings to containers.

FIG. 2 is a top view of the machine shown in FIG. 1.

FIG. 3 is a right side view of the machine shown in FIG. 1.

FIG. 4 is a schematic view of an exemplary container held in a shuttle engaged position.

FIG. 5 is a schematic view representing a portion of the machine frame and a jack usable to selectively change a vertical distance between the exemplary upper and lower conveyor tracks.

FIG. 6 is a schematic view of exemplary circuitry used in connection with controlling operation of an exemplary machine.

FIG. 7 is a transparent schematic view of components included in an exemplary LC shuttle.

FIGS. 8 and 9 are side and top views respectively of an exemplary container including features that can be sensed by the at least one feature sensor for rotatably positioning the container.

FIGS. 10 and 11 are representative of motor drive arrangements that can be utilized for selectively rotating a container in the container engaged position vertically between LC and UC shuttles.

FIGS. 12 and 13 are representative of cam drive arrangements that can be utilized for selectively rotating a container in the container engaged position.

FIGS. 14 and 15 are representative of belt or roller drive arrangements that can be utilized for selectively rotating a container in the container engaged position.

FIGS. 16 and 17 are representative rack and pinion drive arrangements that can be utilized for selectively rotating a container in the container engaged position.

FIG. 18 schematically shows an alternative arrangement including a lower conveyor track and the upper conveyor track which each have a respective continuous drive chain to which the respective LC shuttles and UC shuttles are operatively engageable to provide movement thereof along the respective LC track or UC track.

FIG. 19 is a schematic representation of an approach for providing electrical power and control signals to a plurality of UC shuttles.

FIG. 20 is a schematic representation of an approach for providing electrical power and control signals to a plurality of LC shuttles.

FIG. 21 is a schematic representation of a top view of an alternative arrangement of a machine that includes a respective upper conveyor and a lower conveyor with a respective horizontally adjacent shuttle supporting track.

FIG. 22 is a side view of the machine shown in FIG. 21.

FIG. 23 is a top schematic view of an exemplary movable applicator mount.

FIG. 24 is a front schematic view of an exemplary machine that includes battery powered LC shuttles and an LC track spur with an associated battery charger.

FIG. 25 is a top schematic view of an exemplary machine that includes battery powered LC shuttles, and an LC track spur with an LC shuttle charging station on the LC track.

FIG. 26 is a side view of the machine shown in FIG. 25.

FIG. 27 is a top schematic view of an exemplary machine that includes a plurality of applicators positioned along the LC labeling track portion.

FIG. 28 is a top schematic view of a further exemplary machine that includes a plurality of applicators along the LC labeling track portion.

FIG. 29 is a top right perspective view of an alternative exemplary machine that includes a container suspension conveyor (SC) with shuttles from which containers are suspended.

FIG. 30 is a top right perspective view of an exemplary container engagement fixture in engagement with a shuttle of the arrangement shown in FIG. 29.

FIG. 31 is a right side view of the exemplary container engagement fixture shown in FIG. 30.

FIG. 32 is a top view of the exemplary container engagement fixture shown in FIG. 30.

FIG. 33 is a front view of the exemplary container engagement fixture shown in FIG. 30.

FIG. 34 is a cross-sectional view of the exemplary container engagement fixture taken along line 34 - 34 in FIG. 33.

### DETAILED DESCRIPTION

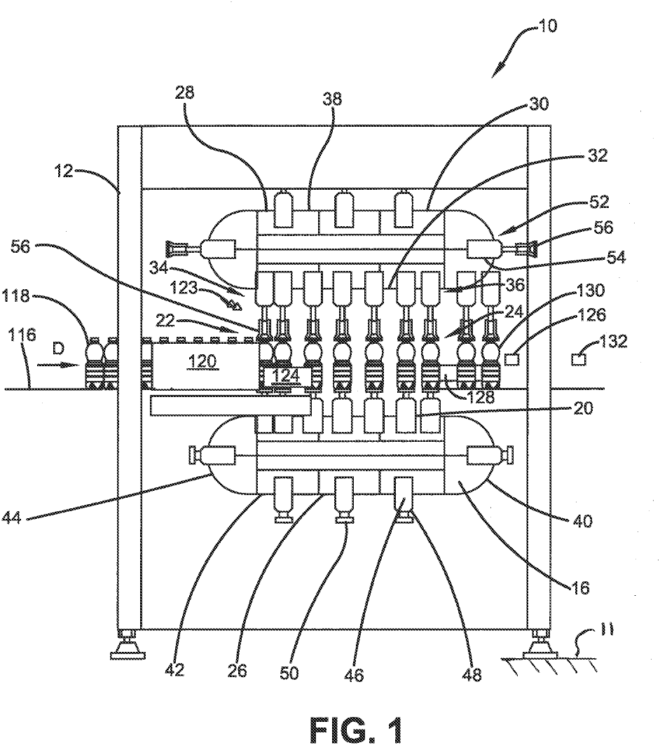

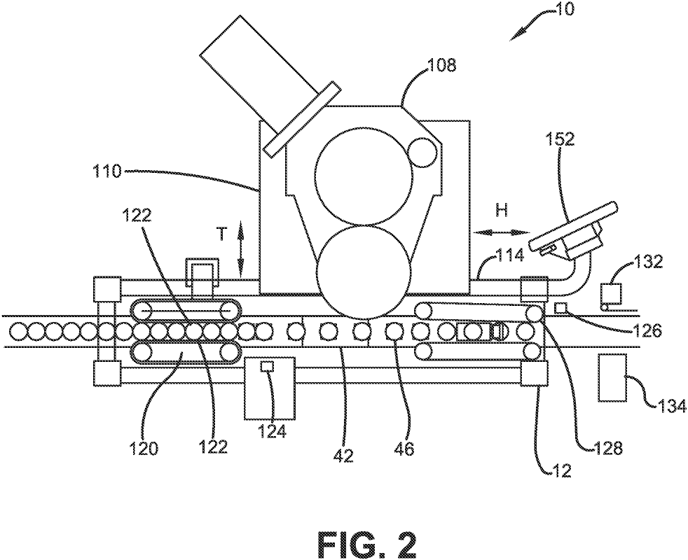

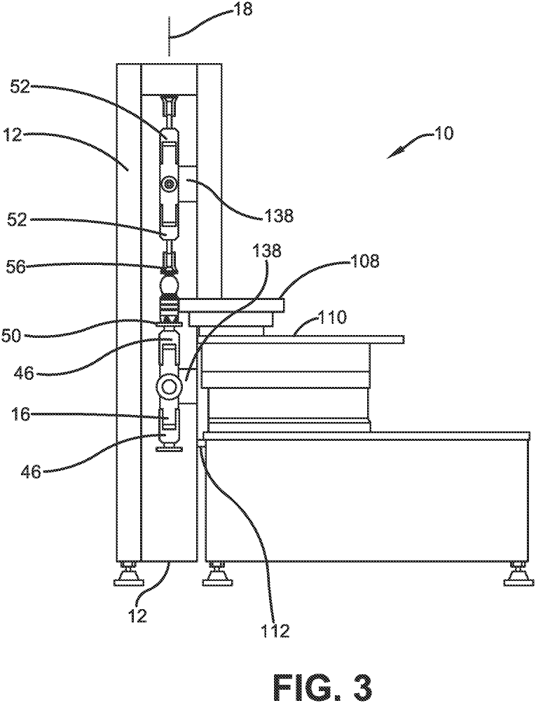

Referring now to the drawings and particularly to FIG. 1 there is shown therein an exemplary machine 10. The exemplary machine 10 is usable to apply markings to containers such as bottles, jars and cans that may be used to house solid or liquid materials. For purposes hereof markings or marks shall be deemed to refer to labels such as paper or plastic patches or sheets, or sleeves that are applied to containers and are attached to containers by adhesives or other fastening methods, as well as indicia or decoration that is printed, sprayed or otherwise applied directly onto a container surface or a label surface. Such markings applied to containers may be informational, decorative or both.

The exemplary machine includes a frame 12. The frame 12 is supported on a floor 11 or other similar support surface. Frame 12 is in operative supported connection with a lower conveyor (LC) 14. The LC includes a continuous LC track 16. In this exemplary arrangement the exemplary LC track has an oval shape and extends in generally a vertically extending plane 18. The LC track includes a substantially linearly straight horizontally extending LC labeling track portion 20. The LC labeling track portion 20 extends at the upper side of the LC track 16. The LC labeling track portion 20 extends between an LC inlet end 22 and LC outlet end 24. LC track 16 further includes a return LC track portion 26. The return LC track portion extends vertically below the LC labeling track portion. The return LC track portion 26 extends between the LC outlet end 24 to the LC inlet end 22. Of course it should be understood that this configuration is exemplary and in other arrangements other configurations may be used.

The exemplary machine 10 further includes an upper conveyor (UC) 28. UC 28 includes a continuous UC track 30. The exemplary UC track 30 has an oval configuration similar to the LC track 16. UC track 30 also extends substantially in vertical plane 18. UC track 30 includes a UC labeling track portion 32. UC labeling track portion 32 extends vertically above and in aligned relation with at least a portion of the LC labeling track portion 20. The UC labeling track portion extends between a UC inlet end 34 and a UC outlet end 36. UC track 30 further includes a return UC track portion 38. The return UC track portion extends above the UC labeling track portion 32 and between the UC outlet end 36 and the UC inlet end 34. Of course it should be understood that this configuration is exemplary and other arrangements other configurations may be used.

In the exemplary arrangement shown in FIG. 1, the LC track and the UC track are comprised of a plurality of modular track pieces 40. Track pieces include a plurality of straight track pieces such as straight track piece 42. The track pieces further include a plurality of curved track pieces such as curved track piece 44. In the exemplary arrangement the straight and curved track pieces are assembled in adjacent relation to provide the LC track and the UC track. Further in exemplary arrangements different numbers of straight track pieces 42 and curved track pieces 44 may be included in the LC and/or UC tracks in order to provide different lengths for the LC labeling track portion and/or UC labeling track portion along which markings may be applied to containers and other functions preformed.

In the exemplary arrangement shown in FIG. 1 a plurality of LC shuttles 46 are movable about the LC track. In the exemplary arrangement each LC shuttle 46 includes a body 48. Each LC shuttle body is in movable engagement with the LC track 16. In exemplary arrangements each LC shuttle body 48 may be engaged to the LC track by rollers, tabs, projections, magnets or other suitable structures that are operative to hold the shuttle body in engagement with the LC track. Of course it should be understood that in some arrangements the LC track may include projections, recesses, rails, magnets or other structures that operate to hold the LC shuttle body in movable engagement with the LC track. The exemplary LC shuttle further includes a container engagement platform 50.

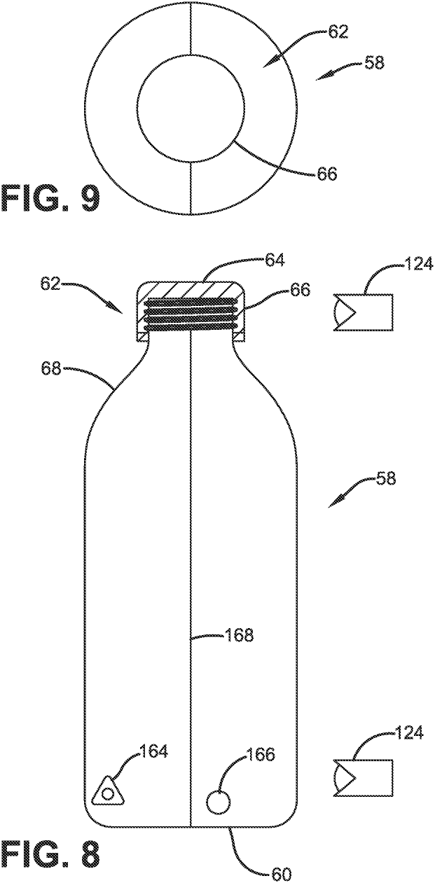

The exemplary container engagement platform 50 is rotatably movably mounted on a respective LC shuttle body 48. The exemplary container engagement platform 50 is configured to engage in operatively supported connection a bottom end of a single container that is to undergo marking by the machine. FIG. 8 shows an example of a container 58 that has a bottom end 60. The container engagement platform 50 is configured to be selectively rotatably movable in ways that are hereinafter discussed so as to selectively angularly position the container that is in supported engagement therewith so as to assure the proper marking of the container.

The exemplary machine 10 further includes a plurality of UC shuttles 52. The exemplary UC shuttles each include a UC shuttle body 54. The exemplary UC shuttle bodies 54 are configured to move about the UC track 30 in a manner similar to the movement of the LC shuttles about the LC track. Each UC shuttle 52 has a container engagement fixture 56 in rotatably movably mounted connection with the respective UC shuttle body. The exemplary container engagement fixture is configured to biasingly engage an upper portion of a container that is disposed upwardly from the bottom end of the container. For example in some exemplary arrangements the container engagement fixture may engage an upper portion 62 adjacent a top 64 of a container such as a cap 66 or lid of a container. In other arrangements the container engagement fixture may be configured to engage a neck 68 or other area of the upper portion of the container. Further it should be understood that while in the exemplary arrangements the container engagement fixture is configured to be rotatably movably mounted on the UC shuttle body, in other arrangements the container engagement fixture may be a stationary relative to the shuttle body, but may enable the container to rotationally move in engagement with the fixture. Of course it should be understood that these arrangements are exemplary and in other arrangements other approaches may be used.

In some exemplary arrangements the LC track and/or the UC track are configured to enable each LC shuttle and/or UC shuttle on the respective track to be moved independently in a controlled manner and independently of the movement of other LC shuttles and UC shuttles on the respective track. For example in some exemplary arrangements one or both of the LC track and UC track may comprise an electromagnetic track which comprises a plurality of spaced electromagnetic elements that are operative to move respective LC shuttles and/or UC shuttles through variable magnetic force. In such arrangements the respective shuttles include magnetic type shuttle drives which are operative to cause the respective shuttle to move responsive to the varied magnetic fields that are generated in the coils or other magnetic elements that comprise the track and/or the shuttle. For example in some arrangements systems providing selective movement of shuttles responsive to changeable magnetic force may be utilized that are commercially available from B & R Industrial Automation GmbH of Eggelsberg, Austria, Rockwell Automation, Inc of Milwaukee, Wisconsin and Beckhoff Automation GmbH & Co. KG of Vert, Germany. In other arrangements conveyor types that include movable shuttles which have shuttle drives that are operative to selectively move the shuttles on a respective track through rotation of wheels, rollers, belts, tracks, balls or other controlled moving members may be utilized.

In other exemplary arrangements the respective conveyor track may include a movable continuous drive chain which is operative to extend about the conveyor track. Such a drive chain 70 is shown on a UC track 72 in the arrangement shown FIG. 18. A motor 74 is in operative connection with the drive chain 70 and is operative to selectively move the drive chain. The UC shuttles 76 are in operative connection with the drive chain 70 such that the UC shuttle 76 can move responsive to movement of the drive chain. Similarly a continuous drive chain 78 extends about an LC track 80. A motor 82 is selectively operative to move the drive chain 78. LC shuttles 84 are in operative connection with the drive chain 78 and are movable about the LC track responsive to operation of the motor 82. In some arrangements the shuttles may have levers, hooks, clutches or other actuators that enable selective operative engagement and disengagement of each shuttle and the drive chain. Of course it should be understood that these approaches to moving the respective LC and UC shuttles described herein are exemplary and in other arrangements other approaches may be used.

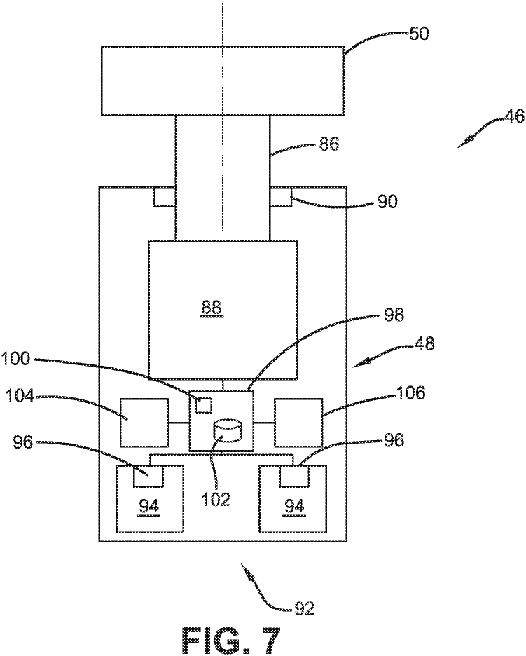

An exemplary LC shuttle 46 is shown schematically in FIG. 7. In the exemplary arrangement the container engagement platform 50 of the shuttle is supported on a rotatable shaft 86 that is in operative connection with a drive 88. In this exemplary arrangement the drive 88 is electrically powered motor such as a servo motor that is housed within the LC shuttle body 48. However in other arrangements other types of drives that are usable to selectively rotate the container engagement platform or other container engagement member may be used. In the exemplary arrangement the shaft 86 is in supported journaled connection with at least one bearing 90.

The exemplary shuttle 46 further includes a shuttle drive 92. In an exemplary arrangement that uses a magnetic type shuttle drive, the shuttle includes a pair of magnetic elements 94. The exemplary shuttle includes sensors 96. In an exemplary arrangement the sensors 96 are operative to provide signals that can be utilized for purposes of determining a current location of the shuttle body on the track. Such sensors may include for example, optical sensors, magnetic sensors, inductance sensors, physical sensors or other suitable sensors that can detect suitable encoder markings or other features that can be utilized for purposes of determining the shuttle location. Of course these components and approaches are exemplary and in other arrangements other shuttle drive components, sensors and other features and approaches may be used.

The exemplary shuttle 46 further includes a shuttle controller 98. The exemplary shuttle controller includes at least one circuit including a processor 100 and at least one data store 102. In the exemplary arrangement the processor may include a processor suitable for carrying out circuit executable instructions that are stored in the at least one data store 102. The processor may include or be in connection with a nonvolatile storage medium including instructions that include a basic input/output system (BIOS). For example, the processor may correspond to one or more or combination of a CPU, FPGA, ASIC or other integrated circuit or other type of circuit that is capable of processing data and instructions. The data store may correspond to one or more of volatile or nonvolatile memory such as random access memory, flash memory, magnetic memory, optical memory, solid-state memory or other device that is operative to store circuit executable instructions and data. Circuit executable instructions may include instructions in any of a plurality of programming languages and formats including, without limitation, routines, subroutines, programs, threads of execution, objects, methodologies, scripts and functions which may carry out the actions such as those described herein. Structures for processors and associated circuitry may include, correspond to, and/or utilize the principles described in the textbook entitled Microprocessor Architecture, Programming and Applications with the 8085 by Ramesh S. Gaonker Sixth Edition (Penram International Publishing, 2013) which is incorporated herein by reference in its entirety.

The exemplary data store used in connection with exemplary arrangements may include any one or more of several types of mediums suitable for holding circuit executable instructions. This may include for example, magnetic media, optical media, solid-state media or other types of media such as RAM, ROM, PROM, flash memory, computer hard drives or some other form of media suitable for holding data and circuit executable instructions. Exemplary controllers may include other components such as hardware and/or software interfaces for communication with the other components of the shuttle or other components of the machine.

The exemplary shuttle 46 further includes a power supply component 104. In some exemplary arrangements the power supply component 104 comprises one or more batteries or other power cells. In other exemplary arrangements the power supply component 104 may comprise a power supply interface which is configured to connect with a power cable or other source of electrical power for purposes of powering the shuttle components. Further in other exemplary arrangements the power supply component may further include components associated with charging the battery such as an inductive charging circuit or other wireless or wired charging circuit suitable for charging the batteries within the shuttle.

The exemplary shuttle further includes an interface component 106. In exemplary arrangements the interface component may include a wireless transceiver which is configured to communicate with a machine controller or other device. In other exemplary arrangements the interface component may include a suitable interface connection to a wired communication connection which provides the control signals that are operative to deliver instructions and data to the shuttle. In some exemplary arrangements the power supply component and the interface component may be in connection with a single wired connection such as a USB connection which is suitable for delivering both electrical power and data and instructions to the shuttle circuitry. Of course it should be understood that these arrangements are exemplary and in other arrangements other approaches may be used.

It should be understood that in exemplary arrangements the UC shuttles 52 may include similar components to the exemplary LC shuttle described. However it should be understood that the LC shuttles may include a container engagement fixture in place of the container engagement platform of the LC shuttles. Further, it should be appreciated that in some arrangements only one of either the LC shuttles or UC shuttles will include a rotatable drive such as the exemplary drive 88 that may be operable to rotate the container. As can be appreciated, in many exemplary arrangements only one type of shuttle may include a drive that is operable to selectively rotate containers. Of course it should be understood that these arrangements are exemplary and in some arrangements the LC conveyor and UC conveyor may utilize different operating principles and have different types of shuttles movable thereon.

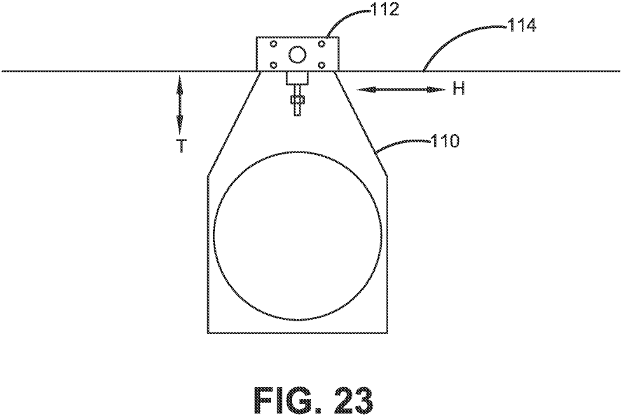

The exemplary machine 10 further includes at least one applicator 108. The at least one applicator of the exemplary arrangement is positioned intermediate of the LC inlet end and the LC outlet end and adjacent to the UC track and the LC track. In the exemplary arrangement the applicator 108 is in operatively supported connection with a movable applicator mount 110. In the exemplary arrangement the movable applicator mount is in operative connection with the frame 12 of the machine. In some exemplary arrangements the applicator mount is in operative connection with at least one releasable clamp 112 which is selectively engageable in fixed engagement with horizontally extending struts 114 or other elements of the frame. In exemplary arrangements the applicator mount 110 is movably positionable horizontally along the direction of Arrow H in FIG. 23. As later discussed Arrow H corresponds to a direction along which containers move as they travel from the LC inlet end to the LC outlet end along the LC labeling track portion. The exemplary applicator mount further enables selective movement of the applicator 108 in a direction transverse to the horizontal direction as represented by Arrow T in FIG. 23. This enables the applicator to be positioned at the desired location both along the path of travel of the containers in the machine as well as at the desired transverse location from the centerline of the containers as may be desirable based on the cross-sectional diameter of the containers subject to being marked through operation of the machine. Of course this approach is exemplary and in other arrangements other approaches may be used.

In exemplary arrangements the applicator may include one or more of numerous different types of applicators that are selectively operative to provide markings to the containers that are processed by the machines. Such applicators may include for example pressure sensitive label (PSL) applicators which are capable of dispensing and applying self adhesive labels to containers. In such devices self adhesive labels are provided on a support film in the form of a continuous web wrapped on rolls or folded in a supply box. The exemplary PSL labeling devices may include an auto splicing device to allow for a continuous label supply even as the end of a roll or other supply of labels is reached. Alternatively or in addition dual labeling device systems may be installed so that when one device reaches the end of its label supply another device automatically commences operation so there is no need to stop or decrease the speed of containers moving through the machine. Exemplary PSL labeling devices may include additional types of printers or markers as well as integrated sensing devices to control the applicator to apply the labels to a container.

Other types of applicators used in exemplary machines may include a cold glue label applicator. Exemplary applicators of this type are operative to dispense and apply paper or plastic patch labels to a container. In exemplary arrangements the labels are supplied individually cut. The labels are loaded in a magazine dispenser. The applicator picks a label from the magazine, applies cold glue to the label and causes the label to be delivered into operative engagement with the container.

Another type of applicator used in exemplary machines may include a cut and stack hot melt label applicator. Such applicators include a mechanism that is able to dispense and apply paper or plastic patch or wrap around labels to a container. In exemplary arrangements the labels are supplied individually cut and are loaded in a magazine. A hot melt adhesive is applied to each respective container and label. Labels are transferred individually to engage with a container and the hot melt adhesive previously applied. In some exemplary arrangements the hot melt adhesive is applied to the container only at the leading edge and to the trailing edge of the label which is wrapped about at least a portion of the circumference of the container.

Other exemplary applicators may include a roll fed hot melt labeling applicator. Such applicators are capable dispensing and applying plastic patch or wrap around labels to a container. In exemplary arrangements the labels are supplied on rolls. The applicator is operative to unwind the rolls and take each label individually from the continuous web of labels supplied on the roll. After cutting, the label is transferred through operation of the applicator through a roller that holds the label through a vacuum or other mechanism. While the label is held the leading and trailing edges of the label are moved to contact a hot melt adhesive roller to provide adhesive to the label. In other arrangements the glue is pre-applied on the label roll. The applicator then pushes the label against the container while the container is rotated to wrap the label around the container circumference. In some exemplary arrangements such applicators are operative to apply adhesive only on the leading edge and the trailing edge of the label. In arrangements where the label extends fully around the container body the adhesive on the trailing edge of the label may operatively engage the trailing edge to the label adjacent to the leading edge.

Other exemplary applicators may include a sleeve labeling applicator. Exemplary sleeve labeling applicators operate to dispense and apply plastic sleeve labels to a container. Such labels are generally supplied in a sleeve form on rolls. The applicator is operative to open the sleeve and cut the sleeve to the correct length. The applicator then dispenses and moves the cut sleeve to surround the cylindrical portion of the container. Once the sleeve is in surrounding relation of the container, the sleeve may be heated or otherwise cause to shrink so as to adhere to the outer cylindrical shape of the container.

Other applicators may include direct printing applicators. Such direct printing applicators may operate to decorate a container by directly printing decorative features of other indicia on the external surface of the container. Such printing applicators may include for example, digital or analog printing devices. Other printing applicators may include inkjet printers, laser printers, stamping printers or other types of printers that are usable to print indicia on the external surface of the container.

Of course it should be understood that these types of applicators are exemplary and in other arrangements other types of applicators may be used.

The exemplary machine 10 further includes a container in feed conveyor 116 which receives incoming containers 118. Incoming containers are received by a feeder 120. In some arrangements the feeder includes a pair of horizontally disposed belt flights 122 that hold and move the containers in single file. In other exemplary arrangements the feeder 120 comprises an in-feed spacing screw. The in-feed screw is operative to receive and move the incoming containers 118 in a single file arrangement and at a desired spacing. In other arrangements other types of feeders may be used. Each feeder is selectively operative to receive containers and deliver the containers in a controlled manner one at a time from the feeder.

At least one incoming container sensor 123 is positioned to sense an incoming container in the feeder 120 in adjacent relation with the LC inlet end 22 and the UC inlet end 34. The feeder is operative to selectively move containers in engagement with the feeder individually in a first direction indicated by Arrow D. At least one feature sensor 124 such as a camera or other image sensor is operative to sense at least one feature of an adjacent container. As later discussed, the at least one feature sensor is used for detecting at least one mark or feature of the container that is usable for purposes of selectively angularly positioning the container for the application of markings thereto by the applicator 108.

In an exemplary arrangement a container outlet conveyor 128 operates to carry containers 130 that have been marked by the applicator 108 away from the LC and UC tracks and out of the machine. In the exemplary arrangement the outlet conveyor 128 may include a pair of horizontally spaced belts, feed screws or other suitable mechanisms for engaging the containers so that they are held upright and move uniformly horizontally away from the LC and UC tracks as they are disengaged by the shuttles at the outlet end of the labelling track. In exemplary arrangements the at least one optical sensor 126 is positioned to sense the markings on the container after the container has been marked by the applicator. In exemplary arrangements the at least one optical sensor 126 may include a camera or other sensor usable to detect optical characteristics of markings that have been applied to containers. The exemplary at least one optical sensor 126 is usable to determine characteristics of markings that are indicative of whether the markings have been properly or improperly applied to each container. The exemplary arrangement shown further includes a diverter 132. The exemplary diverter is operative to direct containers that have been determined not to have had the markings properly applied, onto a divert conveyor 134 or other similar collector which can be used to segregate the containers to which markings were not properly applied from other containers that have been properly marked. Of course this approach is exemplary and in other arrangements other approaches may be used.

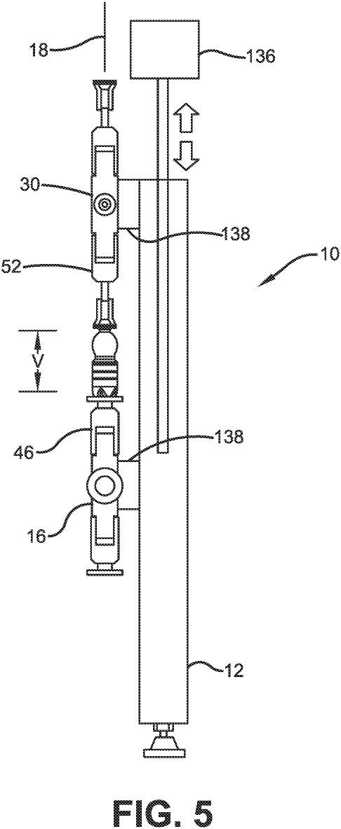

In an exemplary arrangement the LC track and the UC track are movably mounted in operative connection with the frame 12 as represented in FIG. 5. At least one jack 136 is in operative connection with at least one of the LC track and the UC track so as to selectively change a vertical distance V between the LC shuttles 46 and the UC shuttles 52. In some arrangements one or more jacks may be used to selectively position a track relative to other structures such as a supporting floor, applicators or other devices. In some exemplary arrangements the jack may include one or more rotatable jack screws, hydraulic actuators, pneumatic actuators, gear racks or other suitable mechanical devices that can be used for varying the vertical distance between struts 138 that operatively connect the LC track and UC track to the frame 12. In some exemplary arrangements the jack may be manually actuatable to set the vertical distance. In other exemplary arrangements the jack may be operated responsive to electrical signals which are provided responsive to either manual inputs or automatically in response to sensors. This feature of the exemplary arrangement that varies the vertical position or distance facilitates the setup of the machine to handle containers of differing vertical dimensions. Of course it should be understood that this configuration is exemplary and in other arrangements other approaches may be used.

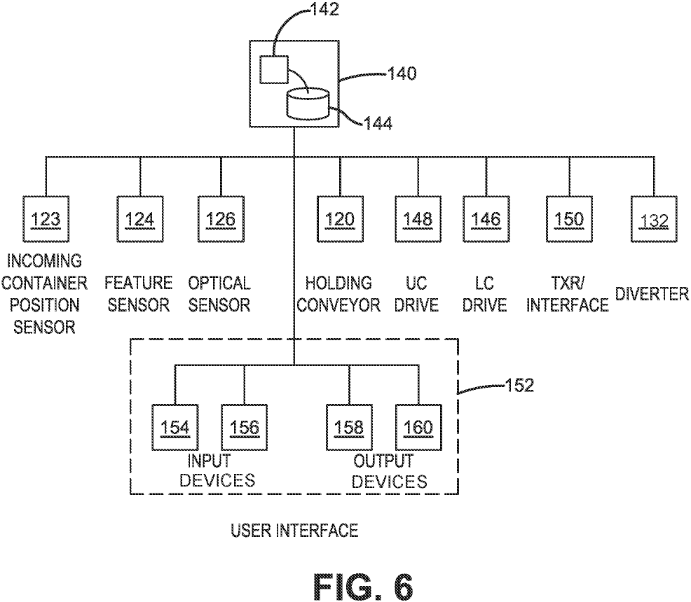

Exemplary circuitry of the machine 10 is schematically represented in FIG. 6. The exemplary machine includes a machine controller 140. The exemplary machine controller 140 includes at least one processor 142 that is in operative connection with at least one data store 144. The at least one processor and data store may have structures like those previously discussed in connection with the shuttle controller 98. The exemplary data store is operative to hold data and circuit executable instructions which are operative to control operation of the exemplary machines in a manner like that later discussed.

In the exemplary arrangement the machine controller 140 is in operative connection with the at least one incoming container position sensor 123 and that the holding conveyor 120. The controller 140 is also in operative connection with the at least one feature sensor 124 and the at least one optical sensor 126. The controller is further in operative connection with at least one LC drive interface 146 which in the exemplary arrangement is operative to communicate signals to control movement of the LC shuttles including the shuttle drives 92 and rotating drives 88 thereon. The controller is further in operative connection with at least one UC drive interface 148. The exemplary UC drive interface is operative to communicate signals to control the UC shuttles including the shuttle drives and container rotating drives thereon, if applicable.

The exemplary machine controller 140 is also in operative connection with an interface 150. In some exemplary arrangements the interface 150 comprises a wireless transceiver that is operative to communicate with the wireless transceivers in the LC shuttles and/or UC shuttles. A wireless transceiver may be utilized in arrangements where shuttle operation is controlled through wireless communication between the machine controller 140 and each of the shuttles. In other exemplary arrangements the interface 150 may comprise a wired connected interface such as those later discussed that may be operative to communicate signals with shuttles for purposes of controlling the operation thereof. Further in exemplary arrangements the machine controller is in operative connection with the diverter 132. The diverter is operative to segregate containers that are determined through operation of the machine controller not to have the markings properly applied thereto.

The exemplary controller is also in operative connection with a user interface 152. The exemplary user interface is operative by a machine user to control the operation of the machine as well as to provide the necessary inputs for purposes of configuring the machine to handle different sized containers. The exemplary user interface 152 includes input devices 154, 156 and output devices 158, 160. The exemplary output devices 158, 160 may include devices such as indicators, dials, displays, warning lights, audible indicators or other devices that output signals or information. The exemplary input devices may include buttons, knobs, a touchscreen input overlay, a pointing device, a microphone or other devices that may receive inputs from the user. Of course it should be understood that these input and output devices are merely exemplary of numerous different types of such devices that may be used. Such input and output devices may be utilized by a user to provide the necessary inputs to the controller 142 to enable machine operation. Such input and output devices may also be utilized by the user to monitor and control operation of the machine.

It should be understood that the exemplary machine controller may also be in operative connection with other devices that are associated with the machine. This may include for example the applicator or applicators that are utilized for purposes of applying markings to containers. Such additional devices controlled and/or monitored through operation of the controller 140 may further include the in feed conveyor 116 and the outlet conveyor 128. In addition in some exemplary arrangements the controller may supply the data which is used to produce the indicia that is applied to containers by an applicator. This may include data such as time and date data that is used to produce the indicia that is applied to containers, for example. Numerous different types of control circuitry may be in operative connection with machines having different arrangements which are operative to provide markings to various types of containers.

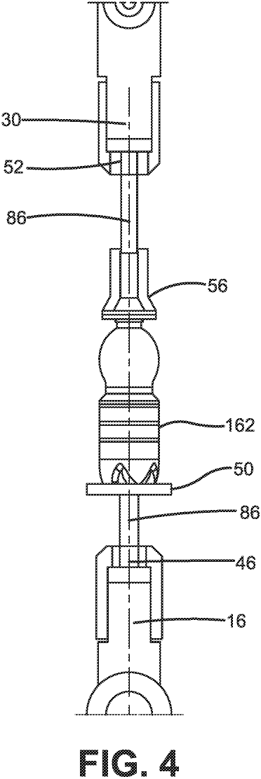

In operation of the exemplary machine 10 the at least one incoming container position sensor 123 is operative to detect a container in the feeder 120 proximate to the LC inlet end 22 and the UC inlet end 34. The machine controller 140 is operative in accordance with the circuit executable instructions in the data store 144, to communicate signals with a respective LC shuttle 46 to cause the shuttle to move into a receiving position on the LC track. In the receiving position the container engagement platform is adjacent to the outlet of the feeder 120. The machine controller 140 is further operative to communicate with a UC shuttle 52 to cause the shuttle to move into a position adjacent to the feeder. The exemplary machine controller 140 then operates the feeder 120 to deliver a container therefrom as the respective LC and UC shuttles are operated to move responsive to the controller and to engage the container vertically between the respective LC shuttle and UC shuttle. This container engaged position of a container 162 is represented in FIG. 4. In this container engaged position the container is engaged between the container engagement fixture 56 of the UC shuttle 52 and the container engagement platform 50 of the LC shuttle 46.

In the operation of the exemplary machine the machine controller 140 operates in accordance with its programming to move the LC shuttle and UC shuttle in coordinated relation in the first direction D to move the container 162 in the container engaged position along the LC and UC labeling track portions. As the container is moved in the container engaged position the at least one feature sensor 124 is operative to sense at least one feature of the container 162. In some exemplary arrangements the at least one feature sensor is operative to sense a registration mark such as mark 164 shown in FIG. 9. In some exemplary arrangements the registration mark may be a mark that is molded into the container at the time of manufacture. In other exemplary arrangements the feature sensor may be operative to sense an applied registration mark 166. Registration mark 166 may comprise a mark that is applied to the container subsequent to manufacture such as for example at the time of filling the container with material. In other exemplary arrangements the at least one feature sensor 124 may be operative to sense a parting line 168 or other mold line. The parting line 168 may constitute a mark that is produced during the manufacturer of the container in the area where mold pieces are separated to release the container from a mold. Such a parting line may be indicative of a particular angular location on the container. Such lines may also include circumferential or other mold form lines or features. Alternatively in other arrangements the at least one feature sensor may be operative to sense a closure piece such as a mark or other feature portion of cap 66.

In exemplary arrangements each of the features sensed through operation of the at least one feature sensor 124 constitute a mark indicative of a particular angular orientation of the container. The machine controller 140 is operative responsive to the at least one feature sensor 124 sensing a location of the mark to make a determination as to the needed rotational movement of the container in order to place it in the desired angular orientation so that the applicator 108 may apply the markings to the container an appropriate manner.

In the exemplary arrangement the controller 140 may operate in accordance with the associated circuit executable instructions in the data store 144 to communicate signals with the drive 88 of the respective LC shuttle to cause rotation of the container engagement platform 50. The signals from the machine controller are operative to cause the container engagement platform 50 to rotate the container in the container engaged position so as to bring the registration mark or other mark on the container into the desired angular registration position. In some exemplary arrangements the movement of the container engagement platform 50 may be monitored through operation of the at least one feature sensor or other sensor to determine when the container is in the desired orientation. Of course as can be appreciated, in the exemplary arrangement where the LC shuttle 46 includes the drive 88 which is operative to rotate the container engagement platform 50, the container engagement fixture 56 on the UC shuttle 52 is operative to rotate with the rotation of the upper portion of the container without substantial resistance. Thus the machine controller 140 is enabled to orient the container in the desired orientation for application of the markings by the applicator 108.

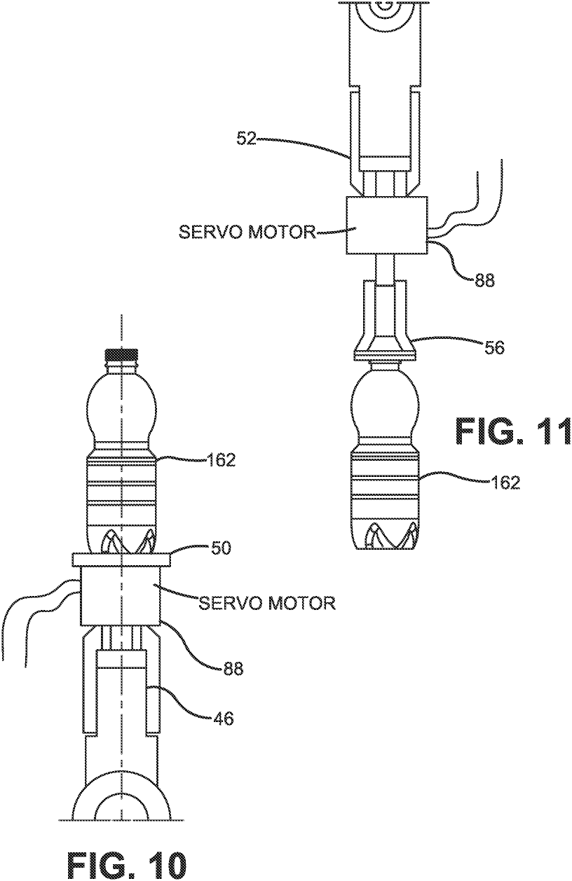

Numerous different drives can be utilized in various machine arrangements for purposes of rotating a container such as container 162 that is in the container engaged position, to the desired angular orientation. For example, FIG. 10 shows schematically a representation of the system previously described in which the drive for the container engagement platform 50 is in operative connection with the LC shuttle that is in engagement with the container 162. FIG. 11 shows the alternative arrangement in which the drive 88 comprises a motor in supported connection with a UC shuttle 52. In such an arrangement the drive 88 is operative to rotate the container 162 through engagement with the container engagement fixture 56.

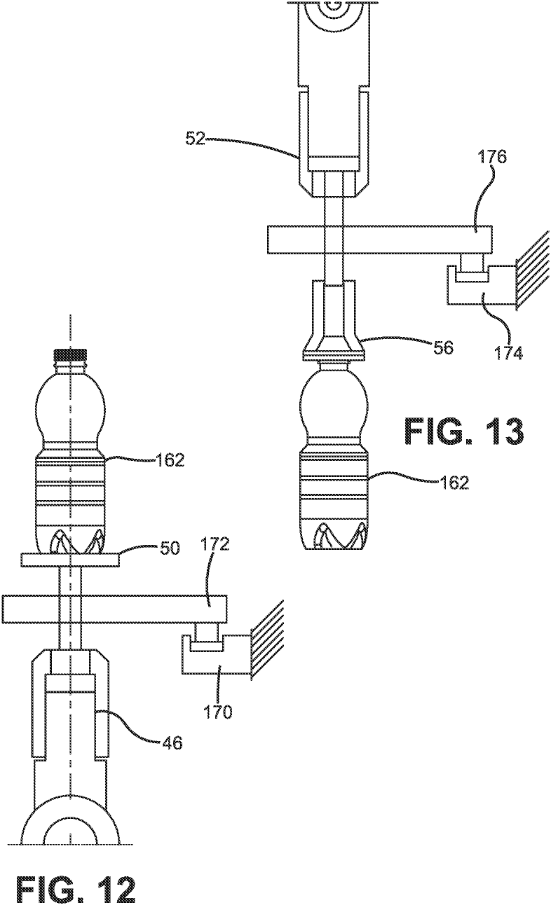

FIG. 12 shows an alternative drive arrangement in which a mechanical cam 170 which is in operatively fixed connection with the frame 12 of the machine is in engagement with the cam follower 172 which is in connection with the container engagement platform 50. In such an exemplary arrangement movement of the LC shuttle 46 is operative to cause movement of the cam follower 172 in engagement with a cam 170 so as to selectively rotate the container engagement platform 150. Alternatively as shown in FIG. 13 a UC shuttle 52 may be in operative connection with a cam 174 through a cam follower 176. In such an arrangement movement of the UC shuttle is operative to cause rotation of the container engagement fixture 56 responsive to relative movement of the cam and cam follower responsive to movement of the shuttle. Of course it should be understood that the degree of permitted rotational movement responsive to cam engagement may be selectively controlled through operation of clutches or other releasible connecting devices responsive to operation of the machine controller 140 so as to provide only the needed amount of container rotation to place the container in the desired angular orientation.

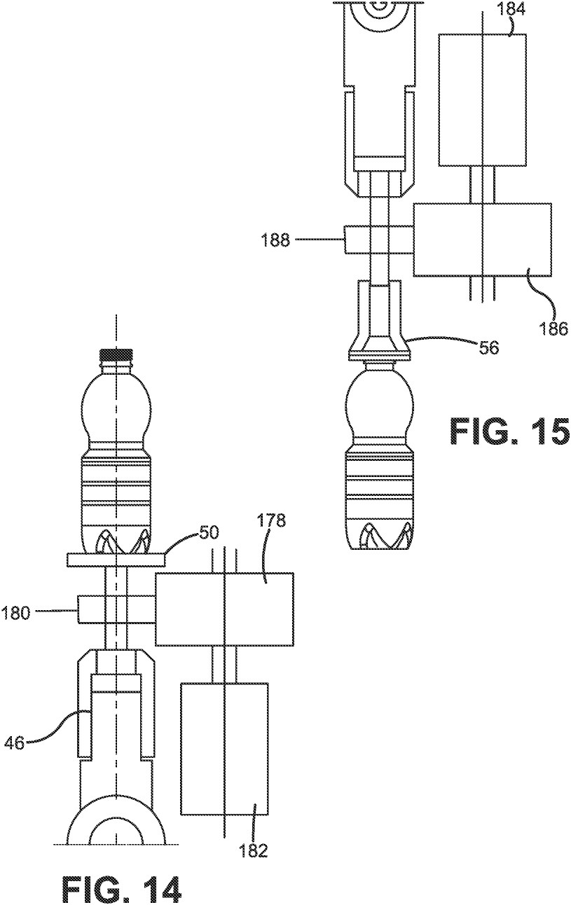

FIG. 14 shows yet a further alternative drive arrangement for selectively rotating a container in the container engaged position between an LC shuttle and UC shuttle. In the arrangement shown, coordinated rotating members such as rollers or pulleys 180 are in operative connection. In some arrangements where pulleys are used the pulleys may be in operative connection through an intermediate flat or toothed belt 178 or similar connector. The belt 178 is moved responsive to a drive motor 182. In exemplary arrangements the drive motor is controlled responsive to the machine controller 140 so as to rotate the container engagement platform 50 and the container supported thereon to the desired angular orientation. FIG. 15 shows an alternative arrangement of the drive which is operative to selectively rotate a container to a desired angular orientation. In this exemplary arrangement a drive motor 184 which is controlled responsive to the machine controller, is operative to rotate operatively connected rollers or pulleys 188 and a flat or toothed belt 186. The connected rollers or pulleys and belt are operative to rotate the container through rotation of the container engagement fixture 56.

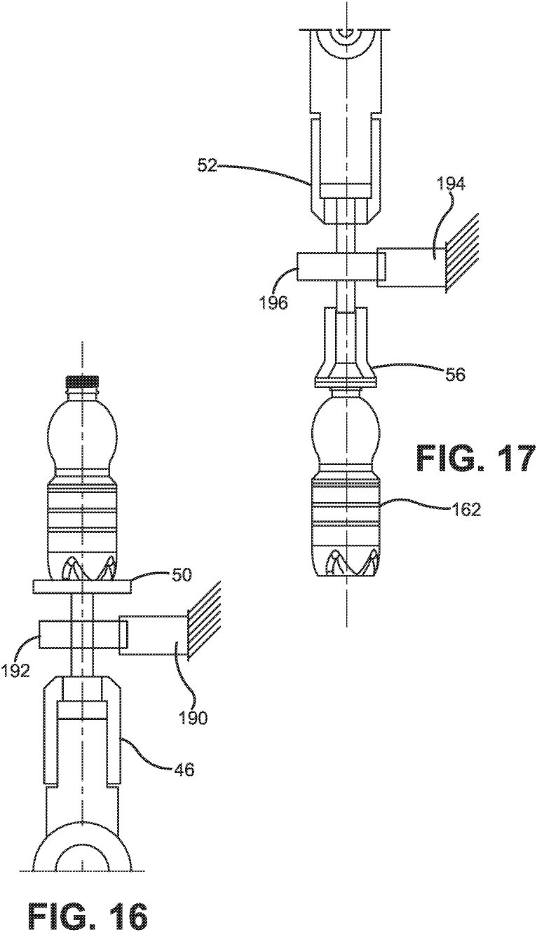

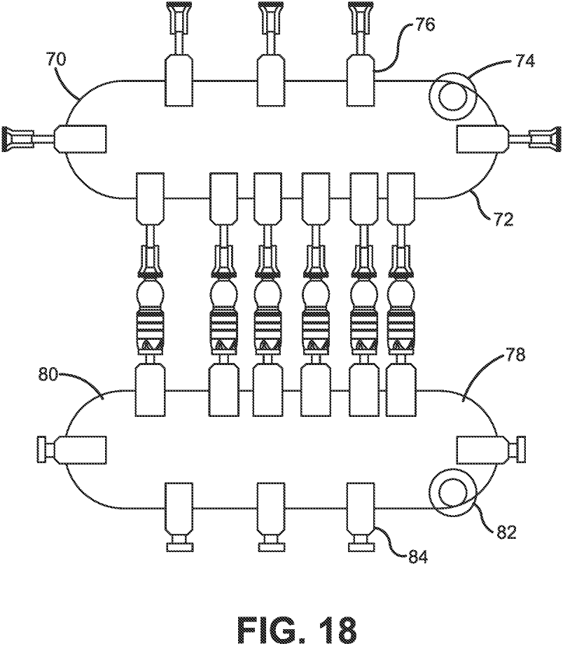

FIG. 16 shows yet a further alternative of a drive that is usable in some exemplary arrangements to selectively rotate a container to desired angular orientation. In this exemplary arrangement the drive includes a gear rack 190 that is in operatively fixed connection with the frame 12 of the machine. The gear rack is in operative engagement with the pinion gear 192 that causes rotation of the container engagement platform 50 responsive to movement of the LC shuttle 46 along the first direction. The machine controller is operative to control the movement of the LC shuttle so as to angularly rotate the container to the desired angular position. Intermediate clutches or other similar mechanisms may be utilized to operatively engage and disengage the gear rack from the container engagement platform. The mechanism may be operative to disengage once the movement of the LC shuttle has resulted in movement of the container to the desired angular position. Similarly FIG. 17 shows a drive that includes a gear rack 194 that is in operative connection with the pinion gear 196. Movement of a UC shuttle 52 is operative to rotate the container engagement fixture 56 in operative connection with the container 162. The container 162 may be rotated responsive to movement of the UC shuttle in operative engagement with the gear rack to the desired angular position.

Of course it should be understood that these drives that may be utilized to provide the rotation of the container to the desired angular orientation for application of the markings by the applicator 108 are exemplary, and in other arrangements other approaches may be used.

In operation of the exemplary machine once the container is moved in the first direction to be in operative connection with the applicator, the applicator operates to apply the markings to the container 162. This may be done through operation of the applicator and appropriate sensors and control circuitry associated therewith. Alternatively in other arrangements the applicator 108 may be controlled by the machine controller 140 in accordance with the circuit executable instructions in the at least one data store 142. As previously discussed, with certain applicators it is necessary to rotate the container while in operative connection with the applicator to apply the markings such as a label around the circumference of the cylindrical cross-section of the container. This may be done in exemplary arrangements through operation of the controller operating a drive such as drive 88 which is housed within a respective LC shuttle or UC shuttle. Likewise rotational movement of the container in operative connection with an applicator may be utilized for purposes of moving the container to apply the markings such as indicia by a stationary inkjet printer or other type printing device. Of course it should be understood that these approaches are exemplary and in other arrangements other approaches may be used.

In the exemplary arrangement once the markings have been applied by the applicator 108, the container 162 is moved in the container engaged position through the coordinated movement of the LC and UC shuttles in the first direction toward the LC outlet end 24. As the UC shuttle in engagement with the container moves along the first direction and reaches the UC outlet end 36, the exemplary UC shuttle moves vertically upward and away from the upper portion of the container. This causes the UC shuttle to disengage from the container. Likewise, as the LC shuttle reaches the LC shuttle outlet end the container moves off the container engagement platform and onto engagement with the outlet conveyor 128. In the exemplary arrangements the machine controller 148 is operative to control the movement of the respective LC shuttle and UC shuttle and the outlet conveyor so as to assure that the container is properly released and placed so as to be in proper upright engagement with the outlet conveyor. Of course it should be understood that while in the described arrangements containers move in one direction along Arrow D, other arrangements may control the shuttles to move in both directions along Arrow D to have various processes performed.

In operation of the exemplary machine after the markings have been applied by the applicator 108, the markings that have been applied are sensed by the at least one optical sensor 126. The at least one optical sensor 126 is operative to sense optical characteristics of the markings that have been applied. For example in exemplary arrangements the at least one optical sensor may include a camera or other similar image capture devices that are operative to determine if the markings have been placed in the appropriate positions on the container, are in the correct orientation, or are otherwise properly applied. Of course in other exemplary arrangements other types of sensors such as contact sensors, electric sensors, magnetic sensors or other types of sensors which may detect aspects of the applied markings may be used.

In the exemplary arrangement the at least one data store includes quality data. The exemplary quality data corresponds to aspects of at least one of proper application of marking to a container or improper application of marking to a container. In exemplary arrangements the quality data may correspond to image data that is indicative of properties or features of labels or other markings that can be detected by the at least one optical sensor and utilized to identify at least one of proper or improper marking. In the exemplary arrangement the machine controller 140 is operative responsive to the quality data and the optical characteristics of the applied markings sensed by the at least one optical sensor, to make a determination concerning whether there is improper marking on the container. In some exemplary arrangements the determination may be based on detection of characteristics that are indicative of improper marking, while in other arrangements the determination may be based on the sensed characteristics not passing certain quality standards which are indicative of proper marking. Of course as can be appreciated numerous different approaches may be taken to identify conditions corresponding to improper marking depending on the particular marking type that is applied, the sensor types and in the nature of the particular container.

Responsive at least in part to the determination that the container contains improper marking the machine controller 140 is operative to generate at least one signal. The at least one signal is operative to cause the container with the improper marking to be segregated from the other containers which have been determined to include proper marking. In exemplary arrangements the at least one signal may be operative to cause the diverter 132 to cause the container with the improper marking to be directed to the divert conveyor 134. Of course this approach is exemplary and in other arrangements other approaches may be used.

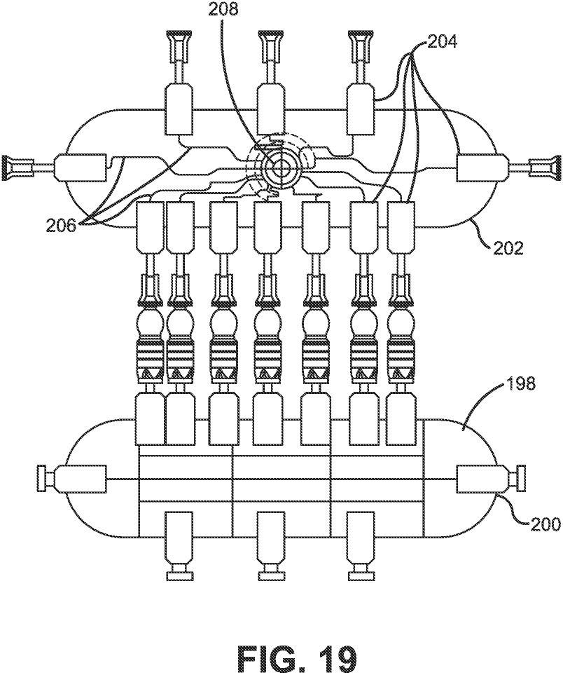

Alternative machine arrangements may include other features which provide for effective operation of the machine. For example an alternative arrangement is shown in FIG. 19 which includes an LC 198 with LC shuttles 200 movable thereon. The alternative arrangement includes a UC 202 with UC shuttles 204 movable thereon. In this exemplary arrangement the UC shuttles 204 are operatively electrically connected to the at least one machine controller through respective cables 206. In the exemplary arrangement the cables are connected to a rotatable connector 208. In this exemplary arrangement each UC shuttle 204 is connected to the rotatable connector 208 by a single dedicated cable 206. As the UC shuttles 204 are moved by each respective shuttle drive responsive to operation of the machine controller, the rotatable connector 208 is operative to rotate so as to reduce the risk of entanglement of the cables. In some exemplary arrangements the rotatable connector may include a motor or other selectively rotatable drive controllable through operation of the controller to maintain the desired orientation of the cables 206. In other arrangements the rotatable connector may be freewheeling and the cables are connected through supports or other connectors which cause the rotation of the connector.

In this exemplary arrangement the cables 206 may be operative to provide electrical power to each respective shuttle, communicate control signals to components of the shuttle, or both. In the exemplary arrangement shown in FIG. 19 the LC 198 and LC shuttles 200 may be of one of the types previously discussed. The LC shuttles 200 may operate responsive to wireless or other signals without a cable connection to provide a power source or control signals to each shuttle. Such arrangement may be desirable for certain types of machines and marking operations.

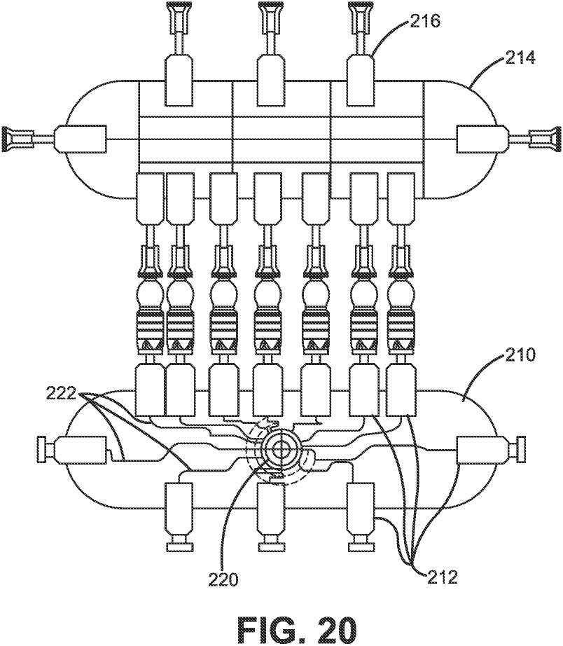

FIG. 20 shows an alternative arrangement which includes an LC 210 with LC shuttles 212 movable thereon. A UC 214 includes UC shuttles 216 that are movable thereon. In this exemplary arrangement a rotatable connector 220 is in operative connection with cables 222. A respective cable 222 electrically connects the rotatable connector 220 with each respective LC shuttle 212. As in the previously discussed arrangement, the LC shuttles 212 may be operative to receive electrical power and/or control communications through the respective cables 222. The UC shuttles 216 may be operative to move in a controlled manner in one of the ways previously discussed. Of course it should be understood that these approaches are exemplary and in other arrangements both the LC and the UC may use cable connections to supply power and/or control signals to some or all of the respective shuttles.

Further it should be understood that other arrangements may include other types of shuttle connections. For example in some arrangements shuttles may be connected in a serial arrangement with cables that extend between shuttles that are immediately adjacent on a respective track. In other example arrangements signals may be communicated with shuttles through magnetic or inductance signals that may be multiplexed or otherwise simultaneously presented in signals that cause other actions such as shuttle movement. Of course it should be understood that these approaches are exemplary and in other arrangements other approaches may be used.

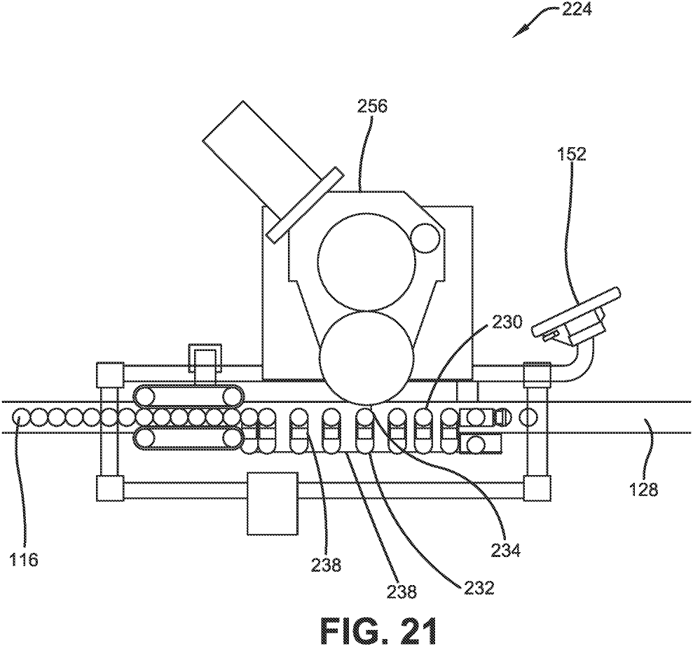

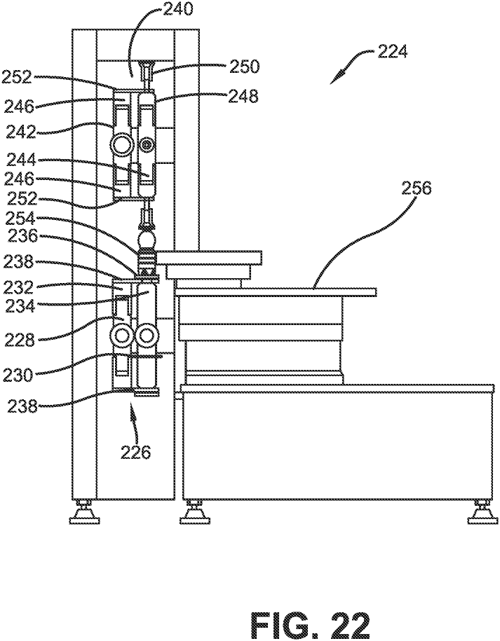

FIGS. 21 and 22 show a further alternative arrangement of a labeling machine 224. Machine 224 may have features similar to those of machines previously described except as otherwise indicated herein. In this exemplary arrangement the exemplary UC and LC each include a conveyor track that is comprised of two parallel side by side tracks. For example, machine 224 has an LC track 226 comprised of an LC drive track 228 and an LC driven track 230. The LC drive track 228 includes a plurality of LC drive track carriers 232 that are movable thereon. The LC drive track carriers 232 may be selectively individually movable in a manner like the shuttles of the previously described arrangements. The LC driven track 230 includes a plurality of movable driven LC shuttles 234 thereon. The driven LC shuttles 234 of an exemplary arrangement may have features similar to the previously described LC shuttles such as a rotatable container engagement platform 236 thereon that is selectively rotatably driven by a drive.

In the exemplary arrangement each of the LC drive track carriers 232 include a releasable connector 238. The releasable connector 238 is operative to releasably engage a respective LC drive track carrier with the respective driven LC shuttle 234. In the exemplary arrangement the releasable connector 238 is operative to cause the respective driven LC shuttle 234 to be selectively moved about the LC driven track 230 responsive to movement of the LC drive track carrier engaged therewith. Further in some exemplary arrangements the respective releasable connector 238 may be in operative connection with an actuator or other mechanism that enables controlled engagement and disengagement with selected driven LC shuttles 234 responsive to operation of the actuator by the machine controller. In some arrangements LC shuttles may be selectively moved in both directions along the LC track. Thus in some exemplary arrangements a single LC drive track carrier 232 may be operative to selectively move different driven LC shuttles 234 through selective engagement and disengagement of the releasable connector 238. This may avoid the need for example, of having a respective LC drive track carrier for each driven LC shuttle of the LC.

In the exemplary arrangement of machine 224 a UC 240 similarly includes a UC drive track 242 and a UC driven track 244. The UC drive track includes a plurality of UC drive track carriers 246 that are selectively movable thereon. The UC driven track 244 includes a plurality of driven UC shuttles 248. In the exemplary arrangement shown, the driven UC shuttles 248 may include features of UC shuttles previously described including having a respective container engagement fixture 250. In the exemplary arrangement each UC drive track carrier 246 includes a releasable connector 252. The releasable connectors 252 may be operative in a manner similar to the releasable connectors 238 previously described to selectively engage and disengage a respective UC drive track carrier 246 and a selected driven UC shuttle 246. Thus in exemplary arrangements the machine controller may operate to engage containers 254 in a container engaged position between a respective driven LC shuttle and a respective driven UC shuttle to be in operative connection with an applicator 256 to apply markings thereto. Of course it should be understood that this arrangement is exemplary, and in other arrangements other approaches may be used.

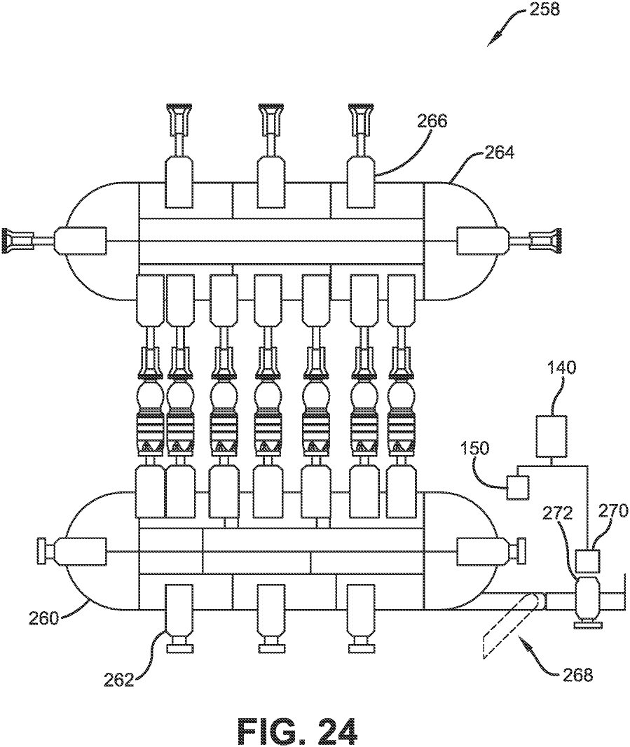

FIG. 24 shows a further alternative machine 258. Machine 258 includes features similar to machine 10 previously described except as otherwise indicated. Machine 258 includes an LC 260 with selectively individually movable LC shuttles 262 thereon. Machine 258 further includes a UC 264 which has selectively movable UC shuttles 266 selectively movable thereon. In this exemplary arrangement the machine controller 140 includes an interface 150 that comprises a wireless transceiver. The wireless transceiver is operative to communicate with the wireless transceiver interface component 106 in each respective LC and UC shuttle so as to cause the machine controller 140 to control the movement thereof.

In this exemplary arrangement the LC shuttles and UC shuttles include rechargeable batteries as part of the power supply component 104. Such rechargeable batteries require periodic recharging in order to maintain the shuttles in operation. In this exemplary arrangement each of the LC track 260 and the UC track 264 include a spur, however only the LC spur 268 is schematically shown. In the exemplary arrangement the spur 268 is engageable with the LC track to enable each respective LC track shuttle to be operatively engaged with the spur. In the exemplary arrangement a battery charger 270 is operatively engageable with shuttles 262 which are in engagement with the spur. This is represented in FIG. 24 by an LC shuttle 272.

In exemplary arrangements a shuttle that has been moved responsive to operation of the machine controller to be located on the spur may be operatively engaged with the battery charger 270. In some exemplary arrangements the battery charger may provide a wired connection or wireless connection for purposes of charging the batteries included in the adjacent shuttle. For example in some arrangements the battery charger 270 may provide a releasable connector plug to provide charging power to a respective shuttle. In other exemplary arrangements the battery charger may include an inductive charging coil that is operative to provide power to an inductive charging coil located in an adjacent shuttle. Of course these approaches for providing power for charging the batteries in a shuttle are exemplary and in other arrangements other approaches may be used.

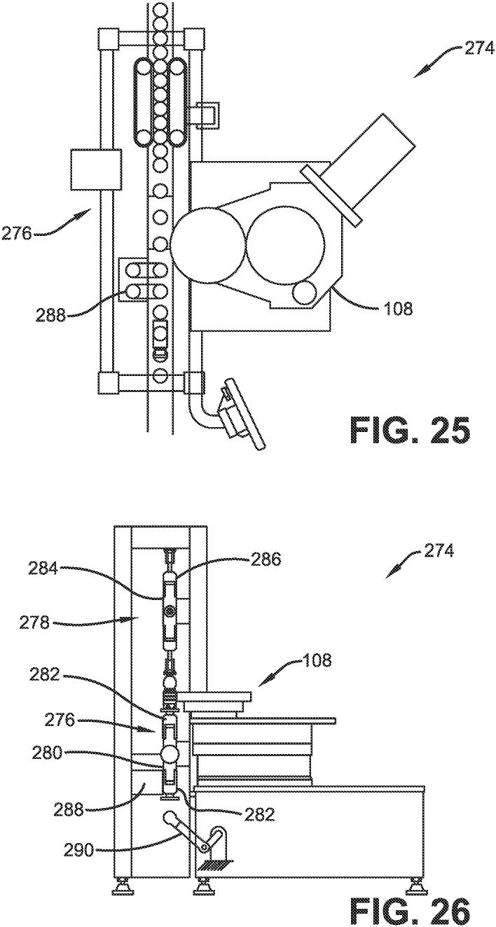

FIGS. 25 and 26 show a further exemplary arrangement of a machine 274. Machine 274 includes features like those described in connection with machine 10 except as otherwise expressly indicated. Machine 274 includes an LC 276 and a UC 278. The LC includes an LC track 280 with movable LC shuttles 282 thereon. UC 278 includes a UC track 284 with movable LC shuttles 286 thereon. In the exemplary machine the shuttles are displaceable transversely of the respective track onto a spur 288 that includes a battery charger. In the Figures this feature is shown only on the LC track 280 but it should be understood that such features may be included in both tracks. In the exemplary arrangement the shuttles are enabled to disengage from the respective UC or LC track and be moved transversely through engagement with a moving device 290, onto the spur 288 for charging. In some exemplary arrangements the moving device 290 may include a pneumatically or electronically controlled pusher or transfer slide. In other arrangements the moving device 290 may include a robotic arm or other mechanisms suitable to provide shuttle movement into engagement with the spur 288.

In various arrangements wireless or wired battery charging methods may be used for charging the shuttle batteries. In this manner the shuttles being recharged on the spur do not interfere with the movement of the shuttles on the respective adjacent track. After being recharged the shuttles may be moved through operation of the moving device 290 or other structure to disengage from the spur so that the shuttles may be utilized to engage and move containers on the respective track. Of course it should be understood that this approach is exemplary and in other arrangements other approaches may be used.

In some arrangements the UC and/or the LC may have multiple different types of LC shuttles and/or UC shuttles. Different shuttle configurations may be used with different container types and configurations. The controller may operate to cause the shuttles that do not correspond to the current container type being processed by the machine to be positioned on a spur. Then if responsive to user inputs through the user interface or in response to sensor signals, the controller determines that a different type of container is going to be processed, the controller operates to cause the shuttles for the different type of container to be moved off the spur onto the main part of the track and the shuttles for the containers no longer being processed are moved onto the spur. Of course this approach is exemplary and in other arrangements other approaches may be used.

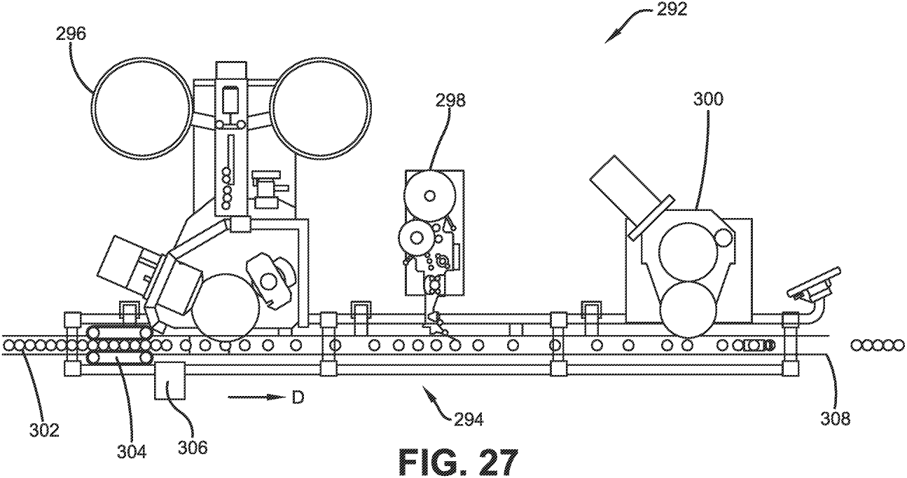

FIG. 27 shows an alternative configuration of the machine generally indicated 292. Machine 292 may include features like those discussed in connection with machine 10 except as described herein. It should be understood that in FIG. 27 only the LC labeling track portion 294 of the machine is shown. It should be understood that machine 292 includes an LC and a UC as well as a UC labeling track portion that corresponds to and extends vertically above the LC labeling track portion.

Machine 292 includes an LC and UC labeling track portion that is longer along the first direction D of container movement than the previously described arrangements. This may be achieved in some machine arrangements by utilizing additional straight and curved track pieces 40 like those previously discussed. In the exemplary arrangement shown, the machine 292 includes three applicators 296, 298 and 300. In the arrangement shown each of the applicators extend on a single lateral side of the machine. Each applicator is disposed from each other along the first direction of container movement. In the exemplary arrangement each of the applicators 296, 298, 300 may apply different kinds of labels or other markings to containers.

In the exemplary arrangement shown, containers are supplied to the machine on an in feed conveyor 302 in a manner similar to that discussed in connection with in feed conveyor 116. Incoming containers are held in a holding feeder 304 that is similar to feeder 120. Containers are engaged in the shuttle engaged position between upper and lower shuttles and moved in the first direction by the shuttles. At least one feature sensor 306 is operative to sense at least one mark on each respective container and to place the container in a selected angular registration position as required for the application of markings by applicator 296. The applicator 296 is operative to apply markings to each container that is engaged in operative connection therewith. After the applicator 296 has completed its marking function the container is moved in engagement with LC and UC shuttles to be in operative connection with applicator 298. Applicator 298 provides further markings to the container. The container is thereafter engaged in the container engaged position in operative connection with applicator 300. Applicator 300 provides additional markings to the container which is then moved further in the first direction and released to an outlet conveyor 308. Of course it should be understood that machine 292 may include additional sensors and other features like those previously discussed for purposes of assuring that markings have been applied properly to each of the containers by each of the applicators.

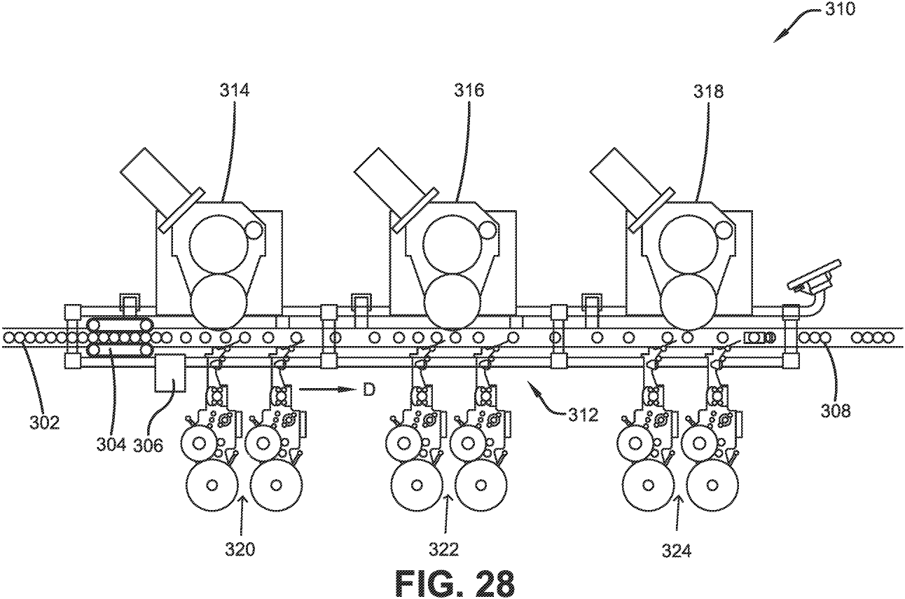

FIG. 28 shows yet another exemplary machine 310. Machine 310 is similar to machine 10 and machine 292 previously discussed, except as otherwise specified. Again as was the case with FIG. 27, only the LC labeling track portion 312 of the machine is shown in the Figure. In this exemplary arrangement six applicators are positioned in operative connection with the LC labeling track portion. In this exemplary arrangement three applicators 314, 316 and 318 are positioned on a first transverse side of the LC labeling track portion. On the opposed side of the LC labeling track portion are three pairs of applicators 320, 322 and 324. In the exemplary arrangement each applicator in each pair is of the same type. Of course this approach is exemplary and in other arrangements other approaches may be used.

The configuration of applicators in machine 310 may be used when numerous different types of labels or other markings are to be applied to each container. In some arrangements each applicator may apply a specific label or other marking that is different from that applied by each of the other applicators. Alternatively such an arrangement may be utilized to help assure that the machine 310 remains operational even in circumstances when one or more applicators go out of service. For example in some arrangements, applicators 314, 316 and 318 may all be configured to apply the same type of marking to a container. In this manner only one of these applicators needs to be operational to perform the function of the machine. If the applicator that is being operated runs out of marking material or malfunctions, another one of the applicators can be automatically started through operation of the machine controller. Similarly in some arrangements only one applicator among the three pairs of applicators 320, 322 and 324 needs to be operational for the machine to perform its functions. Again in the event of an applicator malfunction the other applicator in the same pair, or an applicator in a different pair may be made operational responsive to operation of the machine controller to apply the necessary markings. This exemplary configuration helps to assure that the machine 310 should always be capable of providing the necessary marking functions even if one or more of the applicators are not operational.

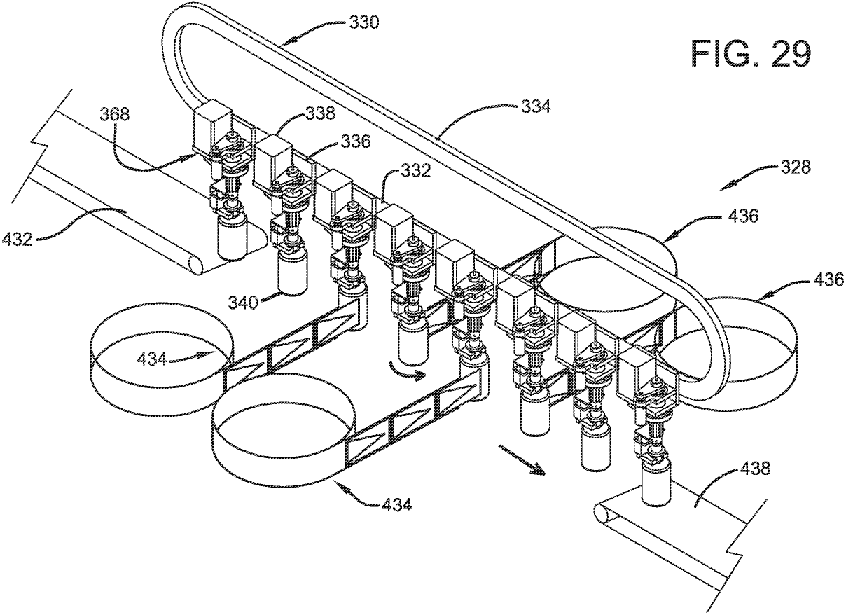

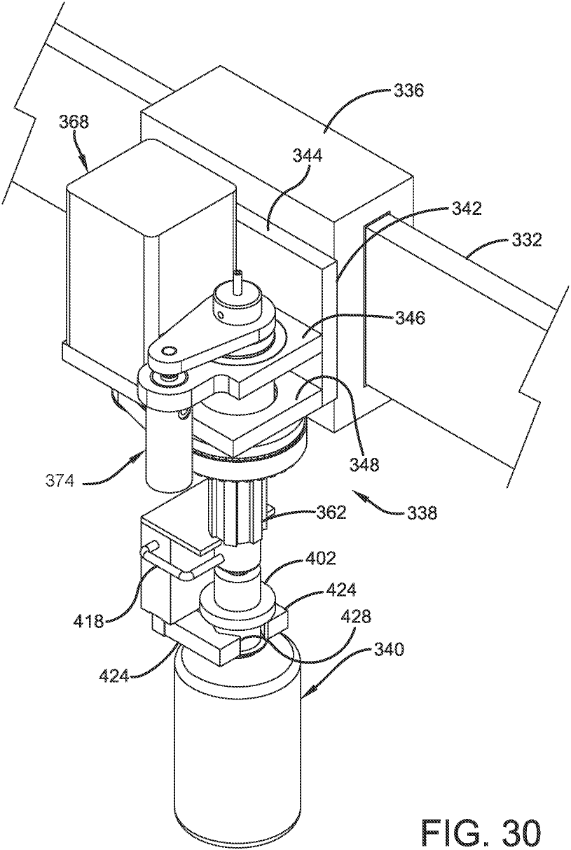

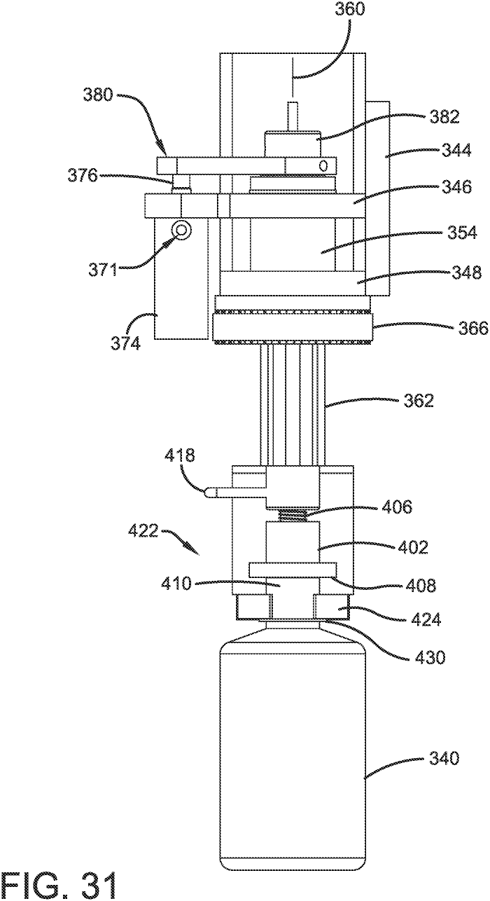

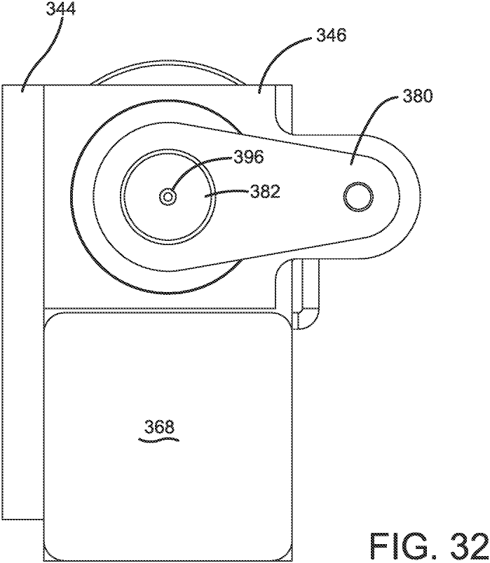

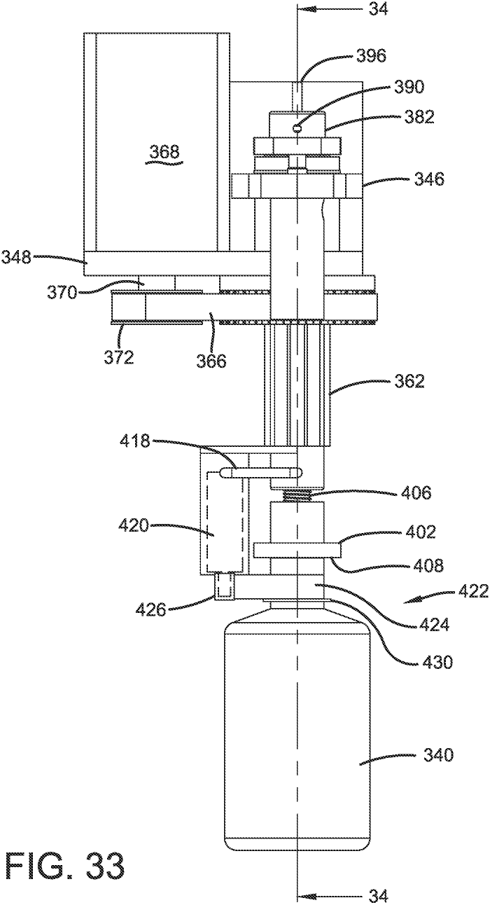

FIGS. 29 - 34 show an alternative exemplary machine 328. Exemplary machine 328 includes a conveyor 330 which may have features similar to a previously described UC or LC, but unlike the previously described arrangements does not include a corresponding lower conveyor. In such exemplary arrangements where upper portions of containers are engaged and moved in suspended relation by a conveyor for positioning and/or marking by an applicator, without the bottom ends of such containers being in contacting relation with a LC or other support surface or other structure during at least a portion of such movement or marking, the conveyor is referred to herein as a suspended container conveyor (SC). The exemplary SC may be suspended above a floor in supported connection with a frame or other structures similar to those previously discussed as supporting a UC. In the exemplary arrangement the SC 330 may be mounted in operative connection with a frame that includes an adjustable jack like that previously discussed that enables selectively vertically positioning the SC relative to the floor. This may be done for purposes of vertically and/or horizontally aligning the SC and the containers that are processed thereon with applicators, in feed conveyors, outlet conveyors and other devices.

Similar to the previously described arrangements the exemplary SC includes a labeling track portion 332 and a return track portion 334. A plurality of shuttles 336 are movable about the entire SC 330. Each of the shuttles has in operative engagement therewith a container engagement fixture 338. Each exemplary container engagement fixture is configured to engage an upper portion of a container 340 in a manner like that later discussed. In the exemplary arrangement the shuttles and container engagement fixtures are operative to engage and transport the containers suspended above the floor through one or more applicator positions with the bottom end of each container not in contacting relation with a support surface. This approach may provide advantages in terms of making certain areas of containers more accessible for marking such as a bottom area of the containers. This approach may also be useful to enable one or more sensors to detect features on containers that may be used for positioning, orienting or identifying containers that may be otherwise difficult to sense or read when a bottom end of the container is in contact with a supporting surface. This arrangement may also be useful for purposes of applying certain types of marking such as sleeves, bottom paint, bottom print or other types of marks that are enabled to be applied by having the bottom end of the containers more accessible.

The exemplary container engagement fixture 338 used in this exemplary arrangement is in attached operative connection and movable with a respective shuttle 336 to selected positions along the SC track. In the exemplary arrangement the SC shuttles are enabled to be selectively moved independently of movement of all of the other shuttles of the machine. This may be done using suitable drives and control systems similar to those that have been previously discussed. Further in the exemplary arrangement the container engagement fixture 338 is selectively operative to engage and disengage from containers such as container 340, as well as to selectively vertically and rotationally position containers that are engagement with the fixture.

In the exemplary arrangement the container engagement fixture 338 includes a bracket 342. In the exemplary arrangement the bracket 342 is in releasably engaged connection with the shuttle 336. The fixture may be engaged with the shuttle through suitable fasteners, pins, magnets, bayonet mounts or other releasable engagement means. The exemplary bracket 342 includes a base plate 344 and a pair of spaced support plates 346 and 348 that extend generally perpendicular to the base plate. Each of the support plates 346, 338 include respective aligned openings 350, 352 therethrough. A hub 354 extends in the openings. A bearing 356 extends in opening 350 and is in operative connection with the hub. A bearing 358 extends in opening 352 and is also in operative connection with the hub. The exemplary bearings enable the hub 354 to rotate in the openings 350, 352 about an axis 360.

In the exemplary arrangement the hub 354 includes a central axially extending opening therethrough. A shaft 362 extends along the axis in the central opening of the hub 354. In the exemplary arrangement the opening in the hub is keyed or splined and has a corresponding configuration to at least a portion of the outer surface of the shaft 362. This enables the shaft 362 to be in rotationally fixed operative engagement with the hub while also being axially movable relative to the hub.

In the exemplary arrangement the hub 354 and the shaft are in operative fixed rotatable connection with a gear pulley 364. The exemplary gear pulley includes a central opening which enables the shaft 362 to move axially relative to the pulley in the central opening. In the exemplary arrangement the gear pulley 364 is a toothed pulley which is engaged with a toothed belt 366. A drive 368 such as a selectively rotatable servo motor is in operative supported connection with support plate 348. The drive 368 includes an output shaft 370 that is in operative connection with a drive pulley 372. The drive pulley 372 in the exemplary arrangement is a toothed pulley that is in operative connection with toothed belt 366. Thus as can be appreciated, the rotation of the drive 368 is enabled to be selectively controlled by a machine controller similar to that previously discussed, so as to rotate and selectively angularly position shaft 362. Of course it should be understood that this arrangement is exemplary and other arrangements other drive approaches may be used.

The exemplary shaft 362 is further in operative connection with an actuator 374. In the exemplary arrangement the actuator 374 is a linear actuator such as a pneumatic cylinder. In other exemplary arrangements other types of actuators such as solenoids, rack and pinion arrangements, feed screws or other actuators that can provide linear motion may be used. The exemplary actuator 374 is in operatively supported connection with support plate 346. The exemplary actuator 374 includes a piston rod 376 that is attached to a movable piston inside the cylinder so that the rod is selectively extendable outward from the actuator. In the exemplary arrangement the piston rod 376 is extendable outward from the actuator responsive to the application of pneumatic pressure through a port 378 of the actuator. In the exemplary arrangement the piston rod 376 is configured to extend a selectable distance outward from the actuator responsive to the level of fluid pressure that is applied to the fluid port 378. In the exemplary arrangement the actuator 374 may include an internal spring or similar functioning device that is operative to provide a force in addition to gravitational force to retract the piston rod when the pressure applied to the fluid port is released. Of course it should be understood that this approach is exemplary and other arrangements other approaches may be used. This may include for example, the application of fluid pressure to a different port of the actuator to move the internal piston and cause the piston rod to retract, or the use of other actuator types as discussed.

In the exemplary arrangement the piston rod 376 of the actuator 374 is in operative connection with an axial control bracket 380. Axial control bracket 380 is in operative connection with a cap 382 that is engaged at an end of shaft 362. In the exemplary arrangement the cap 382 is in journaled relation with the end portion of the shaft through a bearing 384. The bearing 384 enables the shaft to rotate while the cap 382 remains stationary. Further at least one annular seal 386 extends fluidly intermediate of the annular outer surface at the end of the shaft and an inner annular surface of the cap. The exemplary at least one seal 386 is operative to seal a cavity 388 that extends between the end of the shaft and an inner surface of the cap. In the exemplary arrangement the cavity 388 is in fluid connection with a pneumatic port 390.

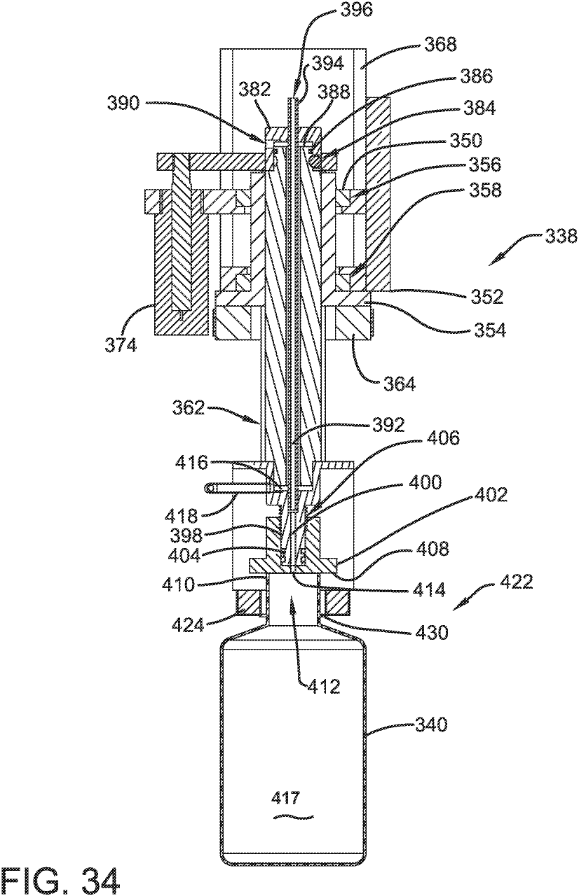

The exemplary shaft 362 includes an axially extending central passageway 392. The passageway includes a tube 394 that extends therethrough. The tube 394 is coaxially arranged with the passageway 392 such that an annular air passage extends on the outside of the tube. As shown in FIG. 34 the tube 394 extends in fluid tight relation through the cap 382. The tube 394 has an external port 396 to which pneumatic pressure may be selectively applied. Further the port 390 and the cavity 388 are isolated from the interior of the tube and are in fluid communication with the annular passageway that extends axially within the shaft on the outside of the tube. Thus the exemplary arrangement provides two separated coaxial compressed air passages through the shaft. In other arrangements other fluid passage configurations or arrangements for applying gas pressure may be utilized.

In the exemplary arrangement the interior area of the tube 394 is in fluid communication with a cylindrical nipple portion 398. Nipple portion 398 includes an air passage 400. A generally cylindrical inflation seal 402 is in telescoping axially movable relation and in fluid tight engagement with the nipple portion. In the exemplary arrangement the inflation seal includes an internal cylindrical cavity in which the nipple portion extends. Annular seals 404 extend radially intermediate of the cylindrical wall bounding the cavity in the inflation seal and the outer wall of the nipple portion 398. In the exemplary arrangement a compression spring 406 is operative to bias the inflation seal 402 toward a container with which the container engagement fixture is engaged. The spring 406 is operative in the exemplary arrangement to provide biasing force that holds an engaging surface 408 of the inflation seal 402 in engaged relation with an annular face surface of a container neck 410 that bounds a container opening 412.

In the exemplary arrangement a fluid passage extends from the air passage 400 in the nipple portion, through the inflation seal and to a gas outlet 414. In the exemplary arrangement the gas outlet 414 enables pressurized gas to be delivered into an interior area 417 of the container 340. This enables the interior area of the container to be pressurized to a selected level above atmospheric pressure so as to enable an empty flexible container to maintain an outer shape during marking that in the exemplary arrangement corresponds to the shape of the container when it is filled with material. As can be appreciated, maintaining the container in the shape that it will have when it is subsequently filled with material helps to assure that markings are properly applied and/or that the container is not deformed when engaged by applicators or labels. However in other exemplary arrangements gas pressure may be utilized to cause the container to be in a configuration during marking or otherwise, that may be different than the configuration that the container will have when subsequently filled with the final product material. This may be done for example to slightly enlarge the container for purposes of engaging certain external positioning structures or for applying markings that are more readily applied when the container is in a deformed condition due to gas pressurization. Further in some situations it may be desirable to reduce pressure within the interior area of the container below atmospheric pressure. This may be done to facilitate surrounding a portion of the container with a marking that includes a surrounding band or sleeve, and then once the band or sleeve is in position, to expand the container through the application of pressure above atmospheric pressure to facilitate engagement of the container and band or sleeve surfaces. Numerous different approaches may be used depending on the nature of the containers and the markings to be applied.

In the exemplary arrangement the port 390 and the annular gas passageway through the shaft on the outside of the tube 394 is in fluid engagement with a passage 416. The exemplary passage 416 is in fluid connection with a tube 418. The tube 418 is fluidly connected to a pair of rotary actuators 420. The rotary actuators are in operative connection with a releasable clamp 422. The releasable clamp is selectively operative to engage and release the neck 410 at the upper portion of the exemplary container 340.

In the exemplary arrangement the clamp 422 comprises a pair of rotatable arms 424. Each arm is in operative connection with the selectively rotatable shaft 426 of a respective rotary actuator 420. In the exemplary arrangement each arm includes a contoured surface 428 that extends in facing relation with a similar mirror image contoured surface of the other arm of the pair. In the exemplary arrangement the contoured surfaces include a pair of angled surfaces that are configured for engaging and holding the neck of a container in fixed engaged relation. Responsive to fluid pressure that is delivered to the port 390, each respective rotary actuator is operative to selectively rotate the respective arm 424 that is engaged therewith toward the other arm. In this condition the contoured surfaces are operative to move closer together and engage the outer surface of the neck of the container. In the exemplary arrangement releasing the air pressure from the port 390 and the rotary actuators 420 is operative to cause the exemplary rotary actuators to rotate the arms away from one another. This causes the contoured engaging surfaces 428 of the respective arms to disengage from the neck. This may be accomplished by torsion springs or other biasing springs. Of course it should be understood that in other arrangements other types of clamps and actuators for holding the upper portions of container in engaged relation may be used.

In the exemplary arrangement the containers include an annular radially extending flange 430. The exemplary flange 430 extends radially outward from the outside of the neck. In the exemplary arrangement the arms are operative to engage the neck in an area of the flange. This facilitates holding the neck and the container in fixed engagement with the arms and in fluid tight engagement with the inflation seal. Of course it should be understood that this approach is exemplary and in other arrangements other approaches for releasably engaging containers in fixed relation with a container engagement fixture may be used.

In operation of an exemplary arrangement a container 340 may be moved to the machine on an inlet feed conveyor 432. In exemplary arrangements the in feed conveyor may be like those previously described which move and support containers thereon by engagement with the bottom end of the containers. In an exemplary arrangement when a container is sensed in a manner like that previously discussed in a position at an inlet end suitable for engagement with the container engagement fixture 338, a machine controller which may be like those previously discussed, is operative to cause the container to be operatively engaged with a shuttle. The controller may be operative to cause a shuttle to move on the SC track to a position in which the shaft of the container engagement fixture 338 is in axially aligned relation with the neck and the opening to the interior area of the container.

In an exemplary arrangement the controller that is in operative connection with the machine may operate to cause the shaft 362 to be rotatably positioned through operation of the drive 368 so as to align the arms 424 to extend generally parallel to the direction of travel of the container on the in feed conveyor 432. In this exemplary arrangement rotationally positioning the arms in this manner facilitates moving the neck of the container in the opening between the arms and between the contoured surfaces 428 when the arms are disposed apart to the respective open positions in which they are not in fixed engagement with a container. Positioning the arms in this manner prior to initial engagement with the neck of the container may facilitate the ability of the inflation seal 402 to move vertically while in engagement with the container neck and reduce the risk of interference by the arms with the flange, threads or other structures on the container neck as the container is being engaged with the fixture. Of course it should be understood that this approach is exemplary and in other arrangements other approaches may be used.

Once the shuttle is moved to the container engaging position the exemplary controller is operative to cause pneumatic pressure to be applied in a controlled manner to the actuator 374 so that the shaft 362 is moved downward toward the container. As the shaft moves axially downward relative to the shuttle the inflation seal 402 engages the annular surface of the container neck 410 that bounds the container opening. The shaft moves downward to the extent that the inflation seal 402 is biased into engagement with the container by the spring 406 and moves in telescoping relation with the nipple portion 398 until the arms 424 are positioned to engage the flange 430 on the neck of the container. In this position the inflation seal 402 and the container opening are engaged in fluid tight relation.

The exemplary controller is then operative to supply fluid pressure to the port 390. This causes air pressure to be applied to the annular passage outside the tube 394. The air pressure is applied through the passage 416 and the tube 418 to the rotary actuators 420. Responsive to the supplied fluid pressure the rotary actuators cause the arms 424 to rotate and move toward one another until they engage opposed sides of the neck 410 in the area of the flange 430. The controller is operative to control one or more valves and/or regulators to hold the air pressure to maintain the arms of the clamp in engaged relation with the container. The controller is then operative to move the shuttle 336 with the container engaged therewith along the labeling track portion 332 toward the one or more applicators schematically indicated 434 and 436. Of course while in the exemplary arrangement the engagement of the container with the container engagement fixture and the shuttle is discussed as occurring with the container being stationary at the inlet end, in other arrangements the engagement of the fixture and the container may occur while both are continuously moving. Such engagement may be accomplished as the container continuously moves toward the applicators on the in feed conveyor and as the SC shuttle continuously moves toward the in feed conveyor and the applicators on the SC track. Accomplishing the operative engagement of the shuttle and the container while both are continuously moving may help to achieve higher production rates.

In the exemplary arrangement the controller is operative to selectively cause the fluid pressure to be delivered to port 396. In the exemplary arrangement the fluid pressure is applied prior to the container being moved to the applicator position along the labeling track portion. The delivery of fluid pressure is controlled such that the interior area of the container is pressurized with gas to a level above atmospheric pressure that is operative to maintain the desired shape of the container during the marking process.

The exemplary controller is also operative to cause the container to be rotatably positioned for proper marking. This may be done using optical sensors or other sensor types to detect particular markings or features on the container so that the angular orientation of the container may be determined. In the exemplary arrangement the drive 368 is operative to cause the shaft 362 to rotate as necessary to detect the container markings using suitable sensors, and to then position the container in the desired rotational orientation. As can be appreciated, in the exemplary arrangement the container is rotationally positionable in clamped relation with the container engagement fixture while gas pressure is held in the container interior area above atmospheric pressure.

In the exemplary arrangement with the clamp of the fixture in engaged relation with the container, the shuttle is movable to transport the container along the labeling track portion 332 of the SC with the container suspended above the floor and with the bottom end of the container not in contacting relation with a supporting surface. Further the exemplary container engagement fixture is operative to vertically position the container through operation of the actuator 374 as may be desirable for purposes of marking by one or more applicators. Thus for example, in one or more applicator positions the container may be vertically positioned so as to achieve proper alignment for operative connection with the applicator to enable suitable marking. Further in some exemplary arrangements the container engagement fixture may be operative to hold different sized containers which have a common neck geometry such that the control circuitry may operate the actuator 374 to position the containers of different sizes in the proper vertical position to have the markings applied by the applicators. Of course it should be understood that the exemplary container engagement fixture 338 may be suitable for engaging different neck geometries due to the configuration of the arms and the available range of rotational movement that is provided through the rotary actuators 420. Of course these approaches and configurations are exemplary and in other arrangements other approaches may be used

Further in exemplary arrangements as represented in FIG. 29, applicators may be positioned on opposed transverse sides of the labeling track portion of the SC. This may facilitate applying different types of labels to containers. Alternatively this arrangement may facilitate faster marking of containers by enabling containers engaged with different respective SC shuttles to be marked by different applicators with the same mark simultaneously. Further as can be appreciated, in exemplary arrangements the ability to suspend and selectively rotationally position the containers through engagement with only the upper portion of the container may facilitate additional types of marking that may not be readily feasible in other arrangements. For example marking that is done by sleeving or marking of the bottom end of the containers may be accomplished more readily in the exemplary arrangements.

Further in the exemplary arrangement the controller may operate to sense for proper application of markings to the containers in a manner like that previously discussed. In the event that improper marking is detected, the exemplary controller may operate in accordance with its circuit executable instructions to cause the container to be disengaged from the container engagement fixture. This can be accomplished for example by the controller causing the fluid pressure to be released from the rotary actuators 420 and causing the arms 424 to move part so as to disengage from the neck and/or flange of the container. In the exemplary arrangement gravity along with the force applied by the spring on the inflation seal 402 and fluid pressure above atmospheric applied to the container interior area is operative to cause the container to disengage from the container engagement fixture. As a result a container that has been subject to improper marking may be readily disengaged from the container engagement fixture and dropped onto the floor or into a waste receptacle for subsequent recycling. This exemplary approach may avoid the need to additionally handle containers that have been subject to unsatisfactory or defective marking.

In the exemplary arrangement containers that have been satisfactorily marked are moved in the shuttle engaged position to an outlet end above an outlet conveyor 438. In exemplary arrangements the outlet conveyor may be of the type previously discussed that is suitable for engaging the bottom end of containers and moving them away from the machine. In the exemplary arrangement the controller may be operative to move the shuttle to a position at an outlet end of the SC track portion in which the container is vertically aligned with the outlet conveyor 438. The controller may be operative to vertically position the container such that the bottom end is positioned in engagement with the upper surface of the outlet conveyor. The controller may be further operative to rotate the container such that the arms are aligned in generally parallel relation with the direction that the container will move in engagement with the outlet conveyor. The controller may then be operative to cause the fluid pressure to be released such that the arms move apart from one another to the open positions. Movement of the arms is operative to cause the contoured surfaces 128 to release the neck of the container. This enables the container to move away from the machine in engaged relation with the outlet conveyor 438. In some arrangements these operations may be accomplished while the containers are continuously moved and transitioned from engagement with the shuttle to the outlet conveyor.

Of course it should be understood that this arrangement is exemplary and in other arrangements other approaches may be used for purposes of container marking. For example in some arrangements it may not be necessary for the interior area of a container to be pressurized above atmospheric pressure for purposes of marking. Further while in the exemplary arrangement the machine is described as operative to carry out marking on empty containers, in other arrangements machines utilizing the principles discussed may be utilized for marking containers that are filled with material. Further it should be understood that while the exemplary arrangement has been described in connection with the marking of generally cylindrical bottles, in other arrangements other types of containers having different configurations may be engaged and marked.

It should be understood that the machine configurations shown herein are merely exemplary of numerous different machine configurations that may be produced utilizing the principles that have been described. Further it should be understood that arrangements with independently movable shuttles may move the shuttles selectively in both directions to cause containers to be marked by applicators in different sequences and/or to be marked by a single applicator multiple times. Further in other exemplary arrangements the shuttle engagement fixture or features thereof may be used with other types of conveyors.

The exemplary machine arrangements described herein present a number of potential advantages compared to prior machines and marking systems. For example, the ability in some arrangements to move each of the shuttles independently on a respective track provides greater flexibility for handling different types of containers, as well as for selectively rotating containers that are in operative connection with applicators. Exemplary arrangements also provide the capability for engaging containers of different physical sizes with the same LC shuttles and/or UC shuttles and/or SC shuttles. Different requirements for rotation of the containers during marking by different applicators may be accomplished by changing the programming associated with the machine controller so that containers are selectively oriented and/or undergo the necessary degree of rotation to successfully apply the markings when in operative engagement with a particular applicator.

Further some exemplary arrangements may have the capability to change the vertical distance between LC and UC shuttles. In other arrangements UC shuttles or SC shuttles may be selectively positioned vertically relative to applicators, or other devices or the supporting floor. This provides the capability to reconfigure the machine for containers having different vertical heights. Other arrangements provide the capability for readily discontinuing the use of existing shuttles that are used in connection with moving one type of container on a respective track, and replacing the existing shuttles with different shuttles that are configured to handle a different type of container. This may include for example shuttles that are made to physically engage containers with different types of cross-sectional configurations, bottom ends and/or upper portions, from those handled by the shuttles that are discontinued. Further exemplary arrangements enable the setting of parameters such as different speeds, distances and spacing between applicators, as well other features and parameters that may be desirable to carry out the marking of containers through operation of the machine.

Exemplary machine arrangements described herein provide potential advantages compared to labeling and marking systems of the rotating carousel type. Such rotating carousel machines commonly support containers by the bottom ends positioned on platforms that have a platform axis of rotation that is parallel to the central axis of the carousel. However, when it is desired to change the type of container that is to be marked through operation of the machine, such as to enable the machine to apply markings to containers with a different diameter in axially transverse cross section, considerable machine modification and set up may be required. Such modifications may include a requirement to change to a different diameter carousel. A different number of container supporting platforms as well as a different number and/or type of marking units may also be required when changing from one container configuration to another.

For example, a carousel machine with a primitive diameter of 600 mm will often have a periphery barely large enough to accommodate four labeling/marking units. If it is desired to add an additional labeling/marking unit, adequate additional space may not be available to do so. Likewise, if it is necessary to add an additional labeling/marking unit, a laser marker, a vision system to detect labeling/marking quality, or other type unit to the machine, the absence of available space may necessitate the use of a larger diameter carousel to accommodate the additional component about the machine periphery.

With carousel machines when it is desired to increase production speed, it is necessary to increase the number of platforms. In a carousel machine this would require an increase in the diameter of the carousel. A change in the diameter of the carousel changes the machine pitch which is the distance between one container and the next container in engagement with the machine. A further consideration is that the application of a label or other marking on a container, whether a partial cold glue label, a self adhesive label, or a wrapping hot melt label, must occur so that the peripheral speeds of the of the labeling/marking device and the external peripheral surface of the container correspond. The necessity to have a common speed for both the label or other marking that is being applied and the peripheral outer surface of the container, is essential to avoid the formation of folds, label slippage, incorrect positioning or other improper markings being applied to the container. This means that the peripheral speed of the applied label or other marking must coincide with the product of the angular velocity of the carousel multiplied by the sum of the radius of the carousel and the radius of the container. The greater the radius of the container, the greater the application speed that must be employed by the labeling or other marking device. As a result the length of the label or other markings to be applied as well as the physical dimensions of the carousel and the container, and the necessary speed for the application of the label or marking must be taken into consideration in the sizing of the pitch of the machine.

With some existing rotating carousel machines it may be difficult to apply a label or other marking that is longer than the machine pitch. As a result for many such machines the machine pitch determines the maximum length of the label or marking that can be applied to a container. Further because the perimeter of the carousel of such machines is circular, the coupling of the labeling or other marking units to the carousel machine must be carried out on the rounded outer periphery. The need to operate the labeling or other marking units so as to achieve proper marking of containers traveling on a generally circular path may present additional complexities.

For some existing rotating carousel machines the changes needed to process containers of different sizes may include a requirement for changing numerous different parts of the machine. Such parts that may need to be changed may include spacing screws, inlet and outlet stars, counter guides and numerous other components. Such items may need to be changed each time the machine needs to be changed to process a dimensionally different type of container. Such changeovers to allow carousel machines to handle different container configurations can be expensive both in terms of the need to acquire different suitable parts to install on the machine as well as the cost of the labor and production downtime necessary to make the machine modifications.

For some of the exemplary machine arrangements described herein the absence of the carousel avoids or substantially reduces drawbacks that may be encountered with certain existing types of machines. Exemplary arrangements of the machines described herein may also include the ability to be more readily and inexpensively configured to handle different sizes of containers as well as to change the number, location and type of applicators that apply markings to containers. Exemplary arrangements may also enable the application of different types of markings and/or markings with larger dimensions, markings on container bottom ends or markings with other properties that might not be possible with some existing machines. Further some exemplary arrangements of the machines described herein may provide advantages in terms of requiring less space for machine operation as well as the capability to provide different desired speeds and production rates. Numerous other potential benefits of the described exemplary machine arrangements will be apparent to those having skill in the field of applying labels or other markings to containers.

Thus the exemplary arrangements described herein achieve improved operation, eliminate difficulties encountered in the use of prior machines and systems, and attain the useful results described herein.

In the foregoing description, certain terms have been used for brevity, clarity and understanding. However no one necessary limitations are to be applied therefrom because such terms are used for descriptive purposes and are intended to be broadly construed. Moreover the descriptions and illustrations herein are by way of examples, and the new and useful features and details are not limited to the exact features and details shown or described.

It should be further understood that the features and/or relationships associated with one arrangement that has been described herein may be combined with features and/or relationships of another arrangement that has been shown or described. That is, various features and/or relationships from various arrangements can be combined in further arrangements. The scope of the disclosure is not limited merely to the arrangements that have been specifically shown or described.

Having described features, discoveries and principles of the exemplary arrangements, the manner in which they are constructed and operated, and the advantages and useful results attained, the new and useful features, devices, elements, arrangements, parts, combinations, systems, equipment, operations, methods, processes and relationships are set forth in the appended claims.

We claim:

1. Apparatus comprising:
a container engagement fixture,
wherein the container engagement fixture is configured to be used as component of a machine that is operative to apply markings to containers,
wherein each of the containers includes a bottom end and an upper portion that is disposed away from the bottom end,
wherein the machine includes
a suspended container conveyor (SC), wherein the SC is configured to move containers engaged by their respective upper portions in suspended relation without the bottom ends of the container being in contacting relation with another conveyor or support surface,
wherein the SC includes
a stationary continuous SC track, wherein the SC track is configured to guide the movement of moveable SC shuttles thereon, wherein the SC track includes
a horizontally extending SC labeling track portion, wherein the SC labeling track portion is disposed vertically away from and above a floor upon which the machine is operatively supported, and extends between an SC inlet end and an SC outlet end,
a return SC track portion,
wherein the return SC track portion extends between the SC outlet end and the SC inlet end,
an SC shuttle,
wherein the SC shuttle
is in operative connection with the SC, and is movable relative to and along the entire SC track,
an applicator, wherein the applicator
is positioned to be operable to apply markings to containers within the SC labeling track portion,
wherein the container engagement fixture comprises:
a bracket, wherein the bracket is configured to be in operative connection with the SC shuttle,
a releasable clamp, wherein the clamp is selectively operative to releasably engage the upper portion of a respective container, wherein in an engaged condition of the clamp and the container, the bottom end of the container is not in supported contacting relation with a support surface,
a drive, wherein in the engaged condition of the clamp the drive is selectively operative to rotate the container about an axis,
wherein the container engagement fixture is selectively operative in the engaged condition and while the container is in operative connection with the applicator, to rotate the container relative to the bracket while a marking is applied to the container.

2. The apparatus according to claim 1
wherein the upper portion of the container includes an opening to a container interior area,
wherein the container engagement fixture further includes:
a gas outlet, wherein pressurized gas above atmospheric pressure is selectively deliverable through the gas outlet,
an inflation seal, wherein in the engaged condition of the clamp, the inflation seal is operative to cause the gas outlet and the container opening to be in sealed fluid connection.

3. The apparatus according to claim 1
wherein the upper portion of the container includes an opening to a container interior area,
wherein the container engagement fixture further includes:
a gas outlet, wherein pressurized gas above atmospheric pressure is selectively deliverable through the gas outlet,
an inflation seal, wherein in the engaged condition of the clamp, the inflation seal is operative to cause the gas outlet and the container opening to be in sealed fluid connection,
a nipple portion, wherein the nipple portion
extends along an axis about which the container rotates relative to the bracket,
includes a nipple fluid passage, wherein the pressurized gas is selectively deliverable through the nipple fluid passage,
wherein the inflation seal
extends in surrounding relation of the nipple portion,
is axially movably mounted in telescoping relation with the nipple portion, and
includes the gas outlet in fluid connection with the nipple fluid passage, a spring, wherein the spring is in operative connection with the inflation seal,
wherein in the engaged condition, the spring is operative to axially bias the inflation seal into sealed relation with the container opening, wherein the gas outlet and the container opening are in sealed fluid connection.

4. The apparatus according to claim 1
wherein the upper portion of the container includes a neck,
wherein the clamp includes
at least one rotary actuator, and
a pair of selectively rotatable arms,
wherein responsive at least in part to air pressure delivered to the at least one rotary actuator, each arm
is selectively rotatable toward the other arm of the pair,
wherein when the clamp is in engaged relation with the container, the arms are operative to hold the neck of the container in horizontally intermediate relation of the arms, and
is selectively rotatable away from the other arm of the pair, wherein the arms are enabled to disengage from the neck of the container.

5. The apparatus according to claim 1
wherein the container rotates relative to the bracket about an axis,
wherein the container engagement fixture further includes
a shaft, wherein the shaft extends along the axis,
wherein the shaft is both selectively axially movable and rotatable relative to the bracket,
wherein the shaft is in supporting connection with the clamp, wherein the clamp is positioned at a first axial end of the shaft, and movable both axially and rotationally with the shaft,
an actuator, wherein the actuator is
operatively engaged with the shaft at a second axial end opposed of the first end, and
selectively operative to axially move the shaft.

6. The apparatus according to claim 1
wherein the container is rotatable relative to the bracket about an axis,
wherein the container engagement fixture further includes
a shaft, wherein the shaft extends along the axis,
a hub, wherein the hub is
rotatably movably mounted in operative supported connection with the bracket, and
is rotatable about the axis,
wherein the shaft extends through the hub, wherein the shaft is in fixed rotatable connection with the hub, and axially movable relative to the hub,
wherein the drive is in operative connection with the hub, whereby the drive is selectively operative to cause rotation of the hub and the shaft that extends through the hub,
wherein the shaft is in operatively supporting connection with the clamp,
wherein the clamp is
positioned at a first axial end of the shaft, and
movable both axially and rotationally with the shaft.

7. The apparatus according to claim 1
wherein the container rotates relative to the bracket about an axis,
wherein the container engagement fixture further includes
a shaft, wherein the shaft extends along the axis,
a hub, wherein the hub is
rotatably movably mounted in operative supported connection with the bracket, and
is rotatable about the axis,
wherein the shaft extends through the hub, wherein the shaft is
in fixed rotatable connection with the hub, and
axially movable relative to the hub,
wherein the drive is in operative connection with the hub, whereby the drive is selectively operative to cause rotation of the hub and the shaft that extends through the hub,
wherein the shaft is in operatively supporting connection with the clamp,
wherein the clamp is
positioned at a first axial end of the shaft, and
movable both axially and rotationally with the shaft,
an actuator, wherein the actuator is
operatively engaged with the shaft at a second axial end opposed of the first axial end, and
selectively operative to axially move the shaft.

8. The apparatus according to claim 1
wherein the container rotates relative to the bracket about an axis,
wherein the container engagement fixture further includes
a shaft, wherein the shaft
extends along the axis, and
includes at least one axially extending gas passageway therein,
a hub, wherein the hub is
rotatably movably mounted in operative supported connection with the bracket, and
is rotatable about the axis,
wherein the shaft extends through the hub, wherein the shaft is
in fixed rotatable connection with the hub, and
axially movable relative to the hub,
wherein the drive is in operative connection with the hub, whereby the drive is selectively operative to cause rotation of the hub and the shaft that extends through the hub,
wherein the shaft is in supporting connection with the clamp,
wherein the clamp is
positioned at a first axial end of the shaft,
movable both axially and rotationally with the shaft, and engageable with the container responsive to gas pressure in the at least one gas passageway,
an actuator, wherein the actuator is
operatively engaged with the shaft at a second axial end opposed of the first axial end, and
selectively operative to axially move the shaft.

9. The apparatus according to claim 1
wherein the container rotates relative to the bracket about an axis,
wherein the container engagement fixture further includes
a shaft, wherein the shaft
extends along the axis, and
includes at least one axially extending gas passageway therein,
a hub, wherein the hub is
rotatably movably mounted in operative supported connection with the bracket, and
is rotatable about the axis,
wherein the shaft extends through the hub, wherein the shaft is
in fixed rotatable connection with the hub, and
axially movable relative to the hub,
wherein the drive is in operative connection with the hub, whereby the drive is selectively operative to cause rotation of the hub and the shaft that extends through the hub,
wherein the shaft is in supporting connection with the clamp,
wherein the clamp is
positioned at a first axial end of the shaft,
movable both axially and rotationally with the shaft,
wherein the clamp includes
at least one rotary actuator,
wherein the rotary actuator is in fluid connection with the at least one gas passageway, and
a pair of movable arms,
wherein the arms are movable responsive to the at least one rotary actuator,
wherein the arms are configured to move to engage the upper portion of the container responsive to gas pressure in the at least one gas passageway.

10. The apparatus according to claim 1
wherein the container is rotatable relative to the bracket about an axis, and includes an opening to a container interior area,
wherein the container engagement fixture further includes
a gas outlet, wherein gas is selectively deliverable through the gas outlet,
an inflation seal, wherein in the engaged condition of the clamp, the inflation seal is operative to cause the gas outlet and the container opening to be in sealed fluid connection,
a shaft, wherein the shaft
extends along the axis, and
includes fluidly separated first and second axially extending gas passageways therein,
a hub, wherein the hub is
rotatably movably mounted in operative supported connection with the bracket, and
is rotatable about the axis,
wherein the shaft extends through the hub, wherein the shaft is
in fixed rotatable connection with the hub, and
axially movable relative to the hub,
wherein the drive is in operative connection with the hub, whereby the drive is selectively operative to cause rotation of the hub and the shaft that extends through the hub,
wherein the shaft is in supporting connection with the clamp,
wherein the clamp is
positioned at a first axial end of the shaft,
movable both axially and rotationally with the shaft,
wherein the clamp includes
at least one rotary actuator,
wherein the rotary actuator is in fluid connection with the first gas passageway, and
a pair of movable arms, wherein the arms are movable responsive to the at least one rotary actuator,
wherein the arms are configured to move to engage the upper portion of the container responsive to gas pressure in the first gas passageway,
wherein the second gas passageway is in fluid connection with the gas outlet,
wherein when the upper portion of the container is engaged by the arms the container interior area is enabled to be pressurized through the second gas passageway to above atmospheric pressure.

11. The apparatus according to claim 1
wherein the container is rotatable relative to the bracket about an axis, and includes an opening to a container interior area,
wherein the container engagement fixture further includes
a gas outlet, wherein gas is selectively deliverable through the gas outlet,
an inflation seal, wherein in the engaged condition of the clamp, the inflation seal is operative to cause the gas outlet and the container opening to be in sealed fluid connection,
a shaft, wherein the shaft
extends along the axis, and
includes fluidly separated first and second axially extending gas passageways therein,
a hub, wherein the hub is
rotatably movably mounted in operative supported connection with the bracket, and
is rotatable about the axis,
wherein the shaft extends through the hub, wherein the shaft is
in fixed rotatable connection with the hub, and
axially movable relative to the hub,
wherein the drive is in operative connection with the hub, whereby the drive is selectively operative to cause rotation of the hub and the shaft that extends through the hub,
wherein the shaft is in supporting connection with the clamp,
wherein the clamp is
positioned at a first axial end of the shaft,
movable both axially and rotationally with the shaft,
wherein the clamp includes
at least one rotary actuator,
wherein the rotary actuator is in fluid connection with the first gas passageway, and
a pair of movable arms,
wherein the arms are movable responsive to the at least one rotary actuator,
wherein the arms are configured to move to engage the upper portion of the container responsive to gas pressure in the first gas passageway,
wherein the second gas passageway is in fluid connection with the gas outlet,
wherein with the arms engaged with the upper portion of the container the container interior area is enabled to be pressurized above atmospheric pressure through the second gas passageway,
an actuator, wherein the actuator is
operatively engaged with the shaft through a rotationally stationary cap at a second axial end opposed of the first axial end, and
selectively operative to axially move the shaft,
wherein at least one of the first gas passageway and the second gas passageway are in fluid connection with a cap fluid passage that extends through the cap.

12. The apparatus according to claim 1
wherein the container is rotatable relative to the bracket about an axis, and includes an opening to a container interior area,
wherein the container engagement fixture further includes
a gas outlet, wherein gas is selectively deliverable through the gas outlet,
an inflation seal, wherein in the engaged condition of the clamp, the inflation seal is operative to cause the gas outlet and the container opening to be in sealed fluid connection,
a shaft, wherein the shaft
extends along the axis, and
includes fluidly separated first and second axially extending gas passageways therein,
a hub, wherein the hub is
rotatably movably mounted in operative supported connection with the bracket, and
is rotatable about the axis,
wherein the shaft extends through the hub, wherein the shaft is
in fixed rotatable connection with the hub, and
axially movable relative to the hub,
wherein the drive is in operative connection with the hub, whereby the drive is selectively operative to cause rotation of the hub and the shaft that extends through the hub,
wherein the shaft is in supporting connection with the clamp,
wherein the clamp is
positioned at a first axial end of the shaft,
movable both axially and rotationally with the shaft,
wherein the clamp includes
at least one rotary actuator,
wherein the at least one rotary actuator is in fluid connection with the first gas passageway, and
a pair of movable arms,
wherein the arms are movable responsive to the at least one rotary actuator,
wherein the arms are configured to move to engage the upper portion of the container responsive to gas pressure in the first gas passageway,
wherein the second gas passageway is in fluid connection with the gas outlet, wherein with the arms engaged with the upper portion of the container the container interior area is enabled to be pressurized above atmospheric pressure through the second gas passageway,
an actuator, wherein the actuator is
operatively engaged with the shaft through a cap at a second axial end opposed of the first axial end,
wherein the cap it is rotationally stationary relative to the shaft and the bracket, and
selectively operative to axially move the shaft,
wherein each of the first gas passageway and the second gas passageway are in fluid connection with a respective cap fluid passage that extends through the cap.

13. The apparatus according to claim 1
wherein the container is rotatable relative to the bracket about an axis, and includes an opening to a container interior area,
wherein the container engagement fixture further includes
a gas outlet, wherein gas is selectively deliverable through the gas outlet,
an inflation seal, wherein in the engaged condition of the clamp, the inflation seal is operative to cause the gas outlet and the container opening to be in sealed fluid connection,
a shaft, wherein the shaft
extends along the axis, and
includes coaxial, fluidly separated first and second axially extending gas passageways therein,
a hub, wherein the hub is
rotatably movably mounted in operative supported connection with the bracket, and
is rotatable about the axis,
wherein the shaft extends through the hub, wherein the shaft is
in fixed rotatable connection with the hub, and
axially movable relative to the hub,
wherein the drive is in operative connection with the hub, whereby the drive is selectively operative to cause rotation of the hub and the shaft that extends through the hub,
wherein the shaft is in supporting connection with the clamp,
wherein the clamp is
positioned at a first axial end of the shaft,
movable both axially and rotationally with the shaft,
wherein the clamp includes
at least one rotary actuator,
wherein the at least one rotary actuator is in fluid connection with the first gas passageway, and
a pair of movable arms,
wherein the arms are movable responsive to the at least one rotary actuator,
wherein the arms are configured to move to engage the upper portion of the container responsive to gas pressure in the first gas passageway,
wherein the second gas passageway is in fluid connection with the gas outlet,
wherein with the arms engaged with the upper portion of the container the container interior area is enabled to be pressurized above atmospheric pressure through the second gas passageway,
an actuator, wherein the actuator is
operatively engaged with the shaft through a cap at a second axial end opposed of the first axial end,
wherein the cap it is rotationally stationary relative to the shaft and the bracket, and selectively operative to axially move the shaft,
wherein each of the first gas passageway and the second gas passageway are in fluid connection with a respective cap fluid passage that extends through the cap.

14. The apparatus according to claim 1
wherein the container is rotatable relative to the bracket about an axis,
wherein the container engagement fixture further includes
a shaft, wherein the shaft
extends along the axis, and
includes at least one splined or keyed portion,
a hub, wherein the hub is
rotatably movably mounted in operative supported connection with the bracket,
is rotatable about the axis, and
in a fixed axial position relative to the bracket,
wherein the at least one splined or keyed portion of the shaft extends through the hub, wherein the at least one splined or keyed portion of the shaft is
in fixed rotatable connection with the hub, and axially movable relative to the hub,
wherein the drive is in operative connection with the hub through at least one of a belt or gear, whereby the drive is selectively operative to cause rotation of the hub and the shaft that extends therethrough,
wherein the shaft is in operatively supporting connection with the clamp,
wherein the clamp is
positioned at a first axial end of the shaft, and
movable both axially and rotationally with the shaft,
an actuator, wherein the actuator is
operatively engaged with the shaft at a second axial end opposed of the first axial end, and
selectively operative to axially move the shaft.

15. The apparatus according to claim 1
wherein the bracket is releasably engageable with the SC shuttle.

16. Apparatus comprising:
a container engagement fixture,
wherein the container engagement fixture is configured to be used as a component of a machine that is operative to apply markings to containers,
wherein each container includes an upper portion including a neck that bounds an opening to an interior area of the container, and a bottom end that is disposed away from the upper portion,
wherein the container engagement fixture is configured to be operatively attached to a movable shuttle,
wherein the movable shuttle is movable in guided relation relative to a stationary continuous track and is movable along the entire track,
wherein the track includes a horizontally extending labeling track portion,
an applicator, wherein the applicator is positioned adjacent to the labeling track portion and is operable apply markings to a respective container in operative engagement with the container engagement fixture of the shuttle within the labeling track portion and while the bottom end is not in engaged relation with a support surface,
wherein the container engagement fixture comprises:
a bracket, wherein the bracket is configured to be in fixed operative connection with a respective shuttle,
a clamp, wherein the clamp includes
at least one arm actuator, and at least one movable arm, wherein the at least one movable arm is in operative connection with the actuator,
wherein the at least one arm actuator is selectively operative to cause the least one arm to
move to an engaged position in which the neck of the respective container is held in immovable engagement with the container engagement fixture, and
move to a release position in which the respective container is disengageable from the clamp,
a rotation drive, wherein the rotation drive
is in operative connection with the bracket, and
is in operative connection with the clamp,
wherein the rotation drive is selectively operative to rotate the clamp and the respective container in immovable engagement therewith about an axis,
a vertical actuator, wherein the vertical actuator
is in operative connection with the clamp, and
is selectively operative to move the clamp between a plurality of vertical positions, wherein the rotation drive is selectively operable to rotate the clamp about the axis in each of the plurality of vertical positions,
wherein the container engagement fixture is selectively operative when the respective container is immovably engaged with the clamp, and the container is in operative connection with the applicator, to rotate the container relative to the axis while at least one marking is applied to the container through operation of the applicator.

17. The apparatus according to claim 16
wherein the container engagement fixture further includes:
a hub, wherein the hub
is in operative supported movable connection with the bracket,
is rotatable relative to the axis and held in a fixed axial position,
wherein the rotation drive is in operative connection with the hub and is selectively operative to rotate the hub,
a shaft, wherein the shaft
extends through the hub,
is in fixed rotational connection with the hub, and
is axially movable while extending within the hub,
wherein the clamp is in operatively attached connection with the shaft at a first axial end.

18. The apparatus according to claim 16
wherein the container engagement fixture further includes:
a hub, wherein the hub
is in operative supported movable connection with the bracket,
is rotatable relative to the axis and held in a fixed axial position,
wherein the rotation drive is in operative connection with the hub and is selectively operative to rotate the hub,
a shaft, wherein the shaft
extends through the hub,
is in fixed rotational connection with the hub, and
is axially movable while extending within the hub,
wherein the clamp is in operatively attached connection with the shaft at a first axial end,
wherein the vertical actuator is in operative connection with the shaft at a second axial end opposed of the first axial end.

19. The apparatus according to claim 16
wherein the container engagement fixture further includes:
a hub, wherein the hub
is in operative supported movable connection with the bracket,
is rotatable relative to the axis and held in a fixed axial position,
wherein the rotation drive is in operative connection with the hub and is selectively operative to rotate the hub,
a shaft, wherein the shaft
extends through the hub,
is in fixed rotational connection with the hub, and
is axially movable while extending within the hub,
includes at least one gas passage that extends axially in the shaft,
wherein the clamp is in operatively attached connection with the shaft at a first axial end, a nipple portion, wherein the nipple portion
extends along the axis,
includes an axially extending nipple fluid passage therein,
wherein the nipple fluid passage is in fluid connection with the at least one gas passage,
an inflation seal, wherein the inflation seal
extends in surrounding relation of the nipple portion,
is axially movably mounted in telescoping relation with the nipple portion, a spring, wherein the spring is in operative connection with the inflation seal,
wherein with the respective container immovably engaged with the clamp, the spring is operative to axially bias the inflation seal into sealed relation with the opening to the interior area, wherein the interior area is enabled to be pressurized to a level above atmospheric pressure through the at least one gas passage and the nipple fluid passage.

20. The apparatus according to claim 16
wherein the container engagement fixture further includes:
a hub, wherein the hub
is in operative supported movable connection with the bracket,
is rotatable relative to the axis and held in a fixed axial position,
wherein the rotation drive is in operative connection with the hub and is selectively operative to rotate the hub,
a shaft, wherein the shaft
extends through the hub,
is in fixed rotational connection with the hub, and
is axially movable within the hub,
includes at least one axially extending gas passage therein,
wherein the clamp is in operatively attached connection with the shaft at a first axial end,
wherein the at least one arm actuator
is in operative connection with the at least one gas passage, and
is operative to cause the at least one arm to move between the engaged position and the release position responsive at least in part to fluid pressure in the at least one gas passage.

21. The apparatus according to claim 16
wherein the container engagement fixture further includes:
a hub, wherein the hub
is in operative supported movable connection with the bracket,
is rotatable relative to the axis and held in a fixed axial position,
wherein the rotation drive is in operative connection with the hub and is selectively operative to rotate the hub,
a shaft, wherein the shaft
extends through the hub,
is in fixed rotational connection with the hub, and
is axially movable within the hub,
includes at least one axially extending gas passage therein,
wherein the clamp is in operatively attached connection with the shaft at a first axial end, wherein the at least one arm actuator
is in operative connection with the at least one gas passage, and
is operative to cause the at least one arm to move between the engaged position and the release position responsive at least in part to fluid pressure in the at least one gas passage,
wherein the vertical actuator
is operatively engaged with the shaft through a rotationally stationary cap at a second axial end opposed of the first axial end, and
wherein the at least one gas passage is in fluid connection with a cap fluid passage that extends through the cap.

22. The apparatus according to claim 16
wherein the container engagement fixture further includes:
a hub, wherein the hub
is in operative supported movable connection with the bracket,
is rotatable relative to the axis and held in a fixed axial position,
wherein the rotation drive is in operative connection with the hub and is selectively operative to rotate the hub,
a shaft, wherein the shaft
extends through the hub,
is in fixed rotational connection with the hub, and
is axially movable within the hub,
includes fluidly separated first and second axially extending gas passages therein, wherein the clamp is in operatively attached connection with the shaft at a first axial end, wherein the at least one arm actuator
is in fluid connection with the first gas passage, and
is operative to cause the at least one arm to move between the engaged position and the release position responsive at least in part to fluid pressure in the first gas passage,
a gas outlet, wherein the gas outlet
is in fluid connection with the second gas passage, and
is configured to deliver gas pressure to the interior area of the container while the container is held in immovable engagement with the container engagement fixture,
wherein the vertical actuator
is operatively engaged with the shaft through a rotationally stationary cap at a second axial end opposed of the first axial end, and
wherein the each of the first and second gas passages are in fluid connection with a respective cap fluid passage that extends through the cap.

23. The apparatus according to claim 16
wherein the container engagement fixture further includes:
a hub, wherein the hub
is in operative supported movable connection with the bracket,
is rotatable relative to the axis while being held in a fixed axial position,
wherein the rotation drive is in operative connection with the hub and is selectively operative to rotate the hub,
a shaft, wherein the shaft
extends through the hub,
is in fixed rotational connection with the hub, and
is axially movable within the hub,
includes fluidly separated coaxially extending first and second gas passages therein,
wherein the clamp is in operatively attached connection with the shaft at a first axial end, wherein the at least one arm actuator
is in fluid connection with the first gas passage, and
is operative to cause the at least one arm to move between the engaged position and the release position responsive at least in part to fluid pressure in the first gas passage,
a gas outlet, wherein the gas outlet
is in fluid connection with the second gas passage, and
is configured to deliver gas pressure to the interior area of the container while the container is held in immovable engagement with the container engagement fixture,
wherein the vertical actuator
is operatively engaged with the shaft through a rotationally stationary cap at a second axial end opposed of the first axial end, and
wherein each of the first and second gas passages are in fluid connection with a respective cap fluid passage that extends through the cap.

24. Apparatus comprising:
a container engagement fixture,
wherein the container engagement fixture is configured to be included in a machine that is operative to apply markings to containers,
wherein each container includes an upper portion that includes a container opening to an interior area of the container, and a bottom end that is disposed away from the upper portion,
wherein the container engagement fixture is configured to be in operatively attached connection with a movable shuttle,
wherein the movable shuttle is configured to be selectively movable relative to and in guided relation along an entire continuous stationary track,
wherein the track includes a horizontally extending labeling track portion,
wherein at least one applicator is positioned adjacent to the labeling track portion and is operable to apply markings to containers in operative engagement with respective container engagement fixtures operatively attached to shuttles within the labeling track portion and while the bottom ends of the containers are not in engaged relation with a supporting surface,
wherein the container engagement fixture comprises:
a bracket, wherein the bracket is configured to be in fixed operative connection with a respective shuttle,
a shaft, wherein the shaft extends along an axis,
wherein the shaft
is selectively axially movable and selectively rotationally movable about the axis in operatively supported connection with the bracket,
includes first and second fluidly separated axially extending internal fluid passages,
a clamp, wherein the clamp includes
a clamp actuator, and
at least one movable arm,
wherein the clamp actuator is operative to cause the at least one arm to move between
an engaged position in which the upper portion of the container is held in immovable engaged relation with the container engagement fixture, and
a release position in which the upper portion of the container is disengageable from the container engagement fixture,
wherein the clamp actuator is in fluid connection with the first fluid passage and is operative to cause the at least one arm to move between the engaged position and the release position responsive at least in part to fluid pressure in the first fluid passage,
a gas outlet,
wherein the gas outlet is in fluid connection with the second fluid passage, an inflation seal, wherein the inflation seal extends in surrounding relation of the gas outlet,
wherein with the container held by the clamp in the engaged position the inflation seal is operative to cause the container opening to be in sealed relation with the gas outlet, and the container interior area is enabled to be pressurized to above atmospheric pressure through the second fluid passage and while the container is rotated about the axis responsive to rotation of the shaft and while at least one marking is applied thereto by the at least one applicator.
